(19) United States
(12) Patent Application Publication
(10) Pub. No.: US 2016/0380489 A1
(43) Pub. Date: Dec. 29, 2016

(54) MULTIPLE-VECTOR INDUCTIVE COUPLING AND ELECTRIC MACHINE

(71) Applicant: Aldan Asanovish SAPARGALIYEV, Almaty (KZ)

(72) Inventor: Aldan Asanovich SAPARGALIYEV, Almaty (KZ)

(21) Appl. No.: 15/121,389

(22) PCT Filed: Mar. 12, 2015
(86) PCT No.: PCT/KZ2015/000004

§ 371 Date: Aug. 25, 2016

(30) Foreign Application Priority Data
Mar. 14, 2014 (KZ) 2014/0325.1

(51) Int. Cl. H02K 1/08; H02K 1/30; H02K 41/02; H02K 1/18

(52) U.S. Cl. CPC H02K 1/08; H02K 1/182; H02K 1/30; H02K 41/02

(57) ABSTRACT

The present invention relates to electric machines (EM), such as electric motors and electric generators, which convert electrical energy into mechanical energy and mechanical energy into electricity respectively, including linear motion EMs, curvilinear motion EMs and rotary (turning) motion EMs. More particularly, the present invention relates to an EM induction method and device, said induction system comprising two main magnetic coupling subsystems, for example a subsystem comprising permanent magnets and a subsystem comprising electromagnets. Thus, EM induction system comprises at least one special feature chosen from the group consisting of the following kinds (a)-(c):

(a) it is configured as a multiple-vector (MV) system and it is configured such as to provide multiple-vector coupling;
(b) at least one of the permanent magnets is selected from the group consisting of: a closed-laminated permanent magnet; and a Π-shaped anti-symmetric group of permanent magnets.
(c) the induction system is vertically configured of multiple rows and comprises, in a vertical direction, two or more electromagnetic induction blocks.

The present invention relates to electric machines (EM), such as electric motors (electro-motors—converting electrical energy into mechanical energy) and electric generators (electro-generators—converting mechanical energy into electricity), including linear EMs, and rotary Ems, using for the production linear power and torque (disk) of the electromotive power, respectively.

More specifically, the present invention relates to a system of inductive-interacting blocks (SIB) apparatus and operating method in the EM, which comprises two or more parts of subsystems of inductive-interacting blocks (SSIB) movable relative to each other.

EMs are so widespread that in any kinds of household and industrial machinery there is one or more EM. In some applications, the electric machine may be operated exclusively as an electric motor, while in other applications the electric machine can operate solely as a generator. EM can selectively operate (dual mode electric machine) either as a motor or a generator.
Depending on the amount of parts moving relative to each other (subsystems of inductive-interacting blocks SSIB), EM may have two or more supports for these SIB parts moving relatively from each other. One of the supports is primary and others are secondary. For example, primary support for the rotary EM is the central support shaft, and for the linear machine—it is supporting platform. For example, in the case when two SIB parts move in the opposite directions or independently, and the third part is fixed relative to them, then three supports are need for three SIB parts.
In the fields of use of EM, where the following requirements stand in the foreground (the main ones are)—small size and high efficiency (efficiency coefficient), the EMs with source-off subsystem (EMSSOEB) are used, containing SSIB with source-offblock (OEB), wherein one of the SSIB is configured in the form of electromagnetic subsystem (SSAMB), while others are configured in the form of source-off subsystem (SSOEB), including permanent magnets.

Currently known are EMSSOEBs with SIB, which contains one of the fractions of single-vector electromagnet ABO: basic fraction, closed fraction and z-integrated fraction.

The most widespread is the EM to with the source-off subsystem EMSSOEB of the rotary movement type (REMSSOEB) with rotary type SIB comprising the basic fraction single-vector electromagnet of the vertical scanning (h-scanning) of the upper side attachment (Ob h—REMSSOEB). To demonstrate some of their specific functional features the following patents should be noted—U.S. Pat. No. 8,508,094 B2, U.S. Pat. No. 8,368,273, U.S. Pat. No. 8,013,489 B2, U.S. Pat. No. 8,310,126 B1, and EP 2466725 A1. In U.S. Pat. No. 8,508,094 B2 offered is Ob h-REMSSOEB with a high concentration of magnetic streams from the rotary permanent magnet. Herewith also suggested are the solutions to compromise optimization problems between the maximum value of torque and the minimum value of its rotor mechanical inertia, on which the OEB is placed. In U.S. Pat. No. 8,368,273 suggested are ways to minimize Ob h-REMSSOEB torque pulsations, based on the selections of air gaps positions between the poles of the permanent magnets OEB, which is placed on the rotor. Thus on the rotor, in its axial direction, several rows of permanent magnets can be placed. In U.S. Pat. No. 8,013,489 B2, unlike in U.S. Pat. No. 8,508,094 B2 and U.S. Pat. No. 8,368,273, the AMB is placed on the torque rotor shaft, which enables to minimize the sizes of low-power electro-motors. In U.S. Pat. No. 8,310,126 B1: for the production of AMB electromagnets it is suggested to use powdered metal rods; it is suggested to regulate the AMB temperature based on the circulation of the cooling liquid through the tube; it is discussed the advantages of the sinusoidal controllers compared with the Hall sensors, while detecting the positions of the permanent OEB magnets with respect to the AMB parts. The detection of the position of the permanent magnets is necessary for the management of AMB electric power in order to vary the OEB movement speeds with respect to the AMB. In EP 2466725 A1 it is proposed to equip the OEB with projections for detecting the position of the permanent OEB magnets with respect to AMB parts.

In order to increase the efficiency coefficient and output power at small sizes of REMSSOEB the interest appears towards the possibilities of creating and using the REMSSOEB with closed fraction SIB (OI-REMSSOEB).

OI-REMSSOEB is divided into two types: vertical scanning (OI h-REMSSOEB), often referred to as Dual-rotor motor, for example, U.S. Pat. No. 7,898,134 B1, US 20080088200 A1; and horizontal scanning (OI λ-REMSSOEB), often referred to as pancake-type motor/generator, for example, US 20060244320 A1, U.S. Pat. No. 8,242,661 B2, US 20130147291 A1.

In U.S. Pat. No. 7,898,134 B1 proposed is the electro-motor OI h-REMSSOEB, in which: the electromagnet core is made of a thin multilayer magnet-soft material; all inductively inhomogeneous environment of the external and internal circle rotors (SSOEB) are configured in the form of individual permanent magnets; winding is made of thick-walled copper; SSOEB is attached to the central support shaft via C-shaped intermediate platform.

In US 20080088200 A1 proposed is the multi-serial (MS—multiserial) electric-generator MS OI h-REMSSOEB, comprising several closed fractions, on the basis of which individual electro-generators are made (configured as a plurality of EM, located along the axial direction), which are components of MS OI h-REMSSOEB.

In US 20060244320 A1 proposed are the options of electro-motor MS OI λ-REMSSOEB, which electromagnets SSAMB are configured with flat spiral shaped coreless windings.

In U.S. Pat. No. 8,242,661 B2 proposed are the MS OI λ-REMSSOEB with different options of geometry of the permanent magnets and their relative position in SSOEB.

In US 20130147291 A1 proposed are construction options of MS OI λ-REMSSOEB and its methods of assembling as a whole. In particular it is suggested: to execute the shoes of electromagnets' cores to be removable; to pack SSAMB in reinforced plastic, while providing channels of SSAMB cooling in reinforced plastic.

In US 20130057091 A1 proposed is the electro-motor comprising a rotary type SIB, z-integrated fraction of vertical scanning.

In practice, also used are linear EMSSOEB with a closed SIB fraction of horizontal scanning (OI λ-LEMSSOEB) rectilinear or curvilinear motion, on which some information is available, for example, in US 20130249324, A1, U.S. Pat. No. 8,587,163 B2 and U.S. Pat. No. 8,593,019 B2.

In US 20130249324 A1 proposed is OI λ-LEMSSOEB with linear motion SIB, in which the geometry of non-magnetic SSOEB cogs are optimized to obtain high efficiency coefficient. In U.S. Pat. No. 8,587,163 B2 proposed is OI λ-LEMSSOEB with reciprocating type SIB, in which the SIB is transfixed by one directing rod.

Known are a number of inventions, for example, US 20090009010 A1, U.S. Pat. No. 8,593,019 B2, U.S. Pat. No. 8,624,446, and US 20130076159 A1, which suggest various EMSSOEB options with SIB fraction, which can be used in the induction system of any of the types of rectilinear, curvilinear and rotational EMSSOEB movement.

In US 20090009010 A1 proposed is the EMSSOEB with a closed SIB fraction, comprising two-way multi-directional pair-flow (double-flow) electromagnet windings at different locations of the permanent magnets on the cogs of SSAMB or SSOEB.

In U.S. Pat. No. 8,593,019 B2, U.S. Pat. No. 8,624,446, and US 20130076159 A1 proposed are EMSSOEB with various options of SIB faction: basic fraction, a fraction of a closed, z—integrated fraction two basic fractions with combined (attached) OEBs in the middle of the SIB.

In U.S. Pat. No. 8,593,019 B2 proposed is EMSSOEB, in which adjacent electromagnets have electrical difference in phase of 180° and at different locations of the permanent magnets on the SSAMB cogs or SSOEB. This paper also discussed the linear LEMSSOEB of the curvilinear motion with the hinges between the AMO.

In U.S. Pat. No. 8,624,446 proposed is the EMSSOEB with blocks SSAMB with ternary winding ensembles of electromagnets, in which the adjacent ensembles of electromagnets have the electrical difference in phase of 60°.

In US 20130076159 A1 proposed is the EMSSOEB with SSAMB blocks with different kinds of winding ensembles of electromagnets. Herewith, one block of SSAMB may consist of several parts.

We have given a brief overview of the inventions to show the level of development of the EM, design features of EM components and introduce the terms suitable for a general review and analysis of various types of EM components and EM as a whole. In known EM inventions, numerous and narrowly specific terms are used.

From this invention review coincides a number of general conclusions for all kinds of known EM.

First, in all known EMs for SSAMB used are single-vector straight-tube (mainly quadrangular shape) electromagnet windings, which at close proximity on both sides (input and output) of the tube provides a single-vector electric field voltage vector.

Second, for the efficient use of input power (to increase efficiency coefficient) and to reduce EM size in its SSOEB or in SSOEB and SSAMB it is advisable to use a system of permanent magnets, which creates a strong magnetic field. The creation of a strong magnetic field using permanent magnets depends on the magnetic power of each magnet, their position relative to each other, and on the external conditions. Some solutions to these problems are described, for example, in U.S. Pat. No. 8,512,590 B2, U.S. Pat. No. 8,400,038 B2, EP 1829188 A1 and US 20130313923 A1. In U.S. Pat. No. 8,512,590 B2 proposed is a process for producing a sintered ferrite-magnet. In U.S. Pat. No. 8,400,038 B2 suggested are ways to focus the magnetic field in order to minimize the magnetic field dissipation. In EP 1829188 A1 proposed are options of mutual arrangement of permanent magnets in SSOEB, in particular in the form of sandwiches, in order to protect them from the demagnetization and strengthening of the magnetic field. In US 20130313923 A1 it is proposed to perform substrates of permanent magnets in SSOEB from the materials of increased thermal conductivity and preventing its strong overheating, which can cause reduction of the efficiency coefficient, as well as demagnetization of the permanent magnets.

The main object of the present invention is to provide a method and EM ensuring effective use of SIB volume, in order to increase the power density (output power ratio to the dimensions of EM) for different EMs. The invention further provides an increase in the efficiency coefficient value. Herewith the proposed options of method of inductive coupling in SIB cover all types of EMs.

The claimed method and the EM satisfy the invention criteria as on the date of filing the application no similar solutions were found. The method and the EM have a number of significant differences from the known methods and devices for their implementation. The proposed method and the EM can be implemented on the basis of existing equipment using reclaimed industrial materials, components and technologies.

The proposed method is implemented by increasing the surface area of the inductive coupling per unit of volume at the decrease in proportion of inefficient part of the winding and the use of strong permanent magnets of a new type.

The main difference between the proposed method and a known method is that SSIB performs inductive interaction between each other on the basis of at least one feature selected from the group (a)-(c):

(a) SIB performs multiple-vector inductive interaction on the basis of the use of at least one electromagnet, selected from the group consisting of the following: combination of at least two single-vector windings, which are configured with a core or without a core; symmetric or anti-symmetric multiple-vector winding, which are configured with a core or without a core;

(b) performs inductive interaction on the basis of the use of at least one kind of permanent magnets selected from the group consisting of the following kinds: closed-layered P_{G}-type permanent magnet; symmetric or anti-symmetric multiple-vector permanent magnet;

(c) provides inductive interaction on the basis of the use of vertically multi-row SIB, which contains vertically more than one AMB.

Other differences between the proposed method and known methods lies in the following:
the inductive interaction is performed in it, wherein the sum of the forces acting perpendicular to the direction of movement of the moving part of SIB, particularly, of rotary EM hub, is zero.
the optimization of curvilinear surface inductive interaction is performed in it.

To implement the main task of the present invention the electric machine (EM) is proposed, which comprises an outer body, a system of supports for different parts of the EM and system of inductive-interacting blocks (SIB), where the SIB is composed of at least two moving subsystems of inductive-interacting blocks (SSIB), each of which includes one or more induction blocks with internal structure, wherein at least one SSIB is electromagnetic subsystem of inductive-interacting blocks (SSAMB), comprising at least one electromagnetic induction block (AMB), the magnet system of which requires the use of alternating electromagnetic field.

The main difference of the proposed magnetic system is that it has at least one feature selected from the group (a)-(c):

(a) its SIB is configured as multiple-vector and allowing multiple-vector inductive interaction between the SSIB and includes at least one electromagnet selected from the group consisting of the following: combination of some single-vector windings, which is configured with a core or without a core; symmetric or anti-symmetric multiple-vector winding, which is configured with a core or without a core;

(b) comprises at least one kind of permanent magnets selected from the group: closed-layered P_{G}-type permanent magnet; symmetric or anti-symmetric multiple-vector permanent magnet;

(c) its SIB is configured vertically multi-row and on a vertical includes more than one AMB.

Other differences of proposed VCSD from the known VCSD lies in the following:
it is configured in one of its kinds:
linear EM with translational type SIB or reciprocating type SIB;
curvilinear EM with translational type SIB or reciprocating type SIB;
rotational EM with SIB selected from the group: of horizontal scanning; vertical scanning; mixed scanning;
it is configured curvilinear with translational type SIB or reciprocating type SIB, in which the moving part of SIB is configured with a hinge between its components and with possibility of moving in a curved shape, wherein a curved shape is corresponding a curvilinear surface of the fixed part of SIB;
it comprises at least one AMB, which vertically-centered lines on the sides of electromagnetic windings are located at an angle α with respect to its base line, where this angle is limited within the 0<α<π range;
the view of its multiple-vector winding and multiple-vector magnet are selected from the group consisting of the following kinds of shapes: one-sided multiple-vector Γ-shaped; symmetric two-sided (Λ-shaped); anti-symmetric two-sided (Λ-shaped);
in it the types of Λ-shaped winding and multiple-vector magnet types are selected from the group consisting of the following kinds: parallel two-sided with the straight upper side; parallel two-sided with the semi-ring upper side; divergent two-sided with the straight upper side; divergent two-sided with the sectoral-ring upper side; sector of the second-order curve;
in it for any kind of Λ-shaped winding and multiple-vector magnet the ratio

$$0 , 02 ≺ \frac{l 2}{l 1} ≺ 2$$

is performed, where introduced are the parameter designations of Λ-shaped form of curved winding and multiple-vector magnet: height l1; width l2; the distance between the lower transverse parts of the winding at its base l3;
its multiple-vector electromagnet comprises a corresponding to multiple-vector armatures of the electromagnet, which belongs to the group of kinds of armatures: Γ-shaped; open symmetric Λ-shaped; closed symmetric Λ-shaped; open anti-symmetric Λ-shaped; closed anti-symmetric Λ-shaped;
in it the types of Λ-shaped armatures are selected from the group consisting of the following kinds: parallel two-sided with the straight upper side; parallel two-sided with the semi-ring upper side; divergent two-sided with the straight upper side; divergent two-sided with the sectoral-ring upper side; forms of a second-order curve;
in it Λ-shaped closed type electromagnet is configured with flat or curved shoes;
in it Λ-shaped open type electromagnet, as part of an open-type electromagnetic block, comprises an outer inter-magnetic bridge-bus configured from the side ends of the electromagnets;
in it Λ-shaped closed type electromagnet, as part of a closed type electromagnetic block, comprises an internal inter-magnetic bridge-bus;
the SIB block structure includes at least one of the blocks' fractions: basic; closed; z-integrated; x-integrated;
the location of blocks in the SIB is configured in the form selected from the group: single-row structure, vertically double-row structure, vertically multi-row structure;
in it the SIB blocks scan is configured in the form selected from the group: vertical, horizontal and mixed;
in it the SIB is configured single-row, wherein, SIB block structure is configured in the form selected from the group of block fractions: basic, closed and z-integrated, which are located in the form of blocks' scan: horizontal, vertical, mixed;
in it the SIB is configured vertically double-row, comprising the source-off (OEB), wherein the SIB block structure is configured in the form of block fractions: basic, closed, z-integrated, x-integrated, which are located inside the EM in the form of: vertical blocks scan for the rows containing non-side OEBs; in any of the types of blocks scans for the rows, one of which consists of side OEBs;
in it the SIB is configured vertically multi-row (three rows or more), wherein the SIB block structure is configured from the fractions selected of the following kinds: basic, closed, z-integrated, x-integrated, which are located in horizontal blocks scan in the EM for the rows not containing non-side OEBs or containing non-side OEBs only on one of the extreme rows;
in it, at the vertical scan of SIB blocks, at least one of its SSIB is configured with the side attachment to the body, with a horizontal SIB blocks scan one of its SSIB is configured with an upper end attachment, at the displaced SIB blocks scan one of its SSIB is configured partially with an upper end and partially with a side attachment;
in it the SIB blocks are located as vertical scan, for the rows containing side or non-side OEBs, wherein the connection region of blocks to each other are attached to the main support of the EM;
in it the SSIBs configured separately from each other are attached to one or to several different side supports;
the winding material of the electromagnet is configured in the form selected from the following group of kinds: wire-wise; plate-wise; print-wise;
the electromagnet winding is configured in the form selected from the group consisting of the following kinds: collected, semi-collected and dispersed;
the electromagnets of each block are configured in the form of a single ensemble or in the form several ensembles that are selected from the group: single, binary, ternary;
the winding material of the electromagnet is configured of the wire/plate of a large section in order to minimize resistive losses;
in the two-stream side winding socket, the currents' direction in both streams is configured in the form selected from the group: parallel, anti-parallel;
each of the ensembles of electromagnets is secured to its single base (bridge/bus) of magnetic-soft material;
in it the electromagnet is selected from the group, consisting of the following kinds: coreless with a flat winding (e.g. spiral-wise); coreless a bulk winding (e.g. self-supporting with quadrangular carcass framing); with a core of magnetic-soft material configured with a shoe or without a shoe; with a core of magnetic-soft material configured with one or more magnets on the shoe or on the cog; with a core of magnetic-soft material made of the magnet in the core kernel; with a core made of a permanent magnet;
the shoe of the core is made of magnetic-soft material;
the magnetic-soft material is performed selected from the group consisting of the following kinds: stamped and stowed large number of metal plates sheets; twisted metal plate; powdered magnetic-soft material (sintered ferromagnetic); composite material;
the shoe of the core is configured in a form of partially or completely removable from the cap of the core;
it is configured in the form of EMSSOEB with source-off subsystem, wherein at least one of SSIB is configured in the form of source-off subsystem (SSOEB), and includes induction-inhomogeneous environment selected from the group comprising the following kinds: periodic protrusions and recesses (multi-cogged) made of magnetic-soft material; with co-directional and anti-directional permanent magnets of a periodic location on the surface, partially in the pocket or completely in the pocket of magnetic-soft material with air recesses or without recesses between the magnets;
it is configured with co-directional or anti-directional permanent magnets, wherein the OEB surface is configured in the form selected from a group: (a) periodically petal-shaped convex; (b) of a uniform height with periodic air recesses or without them; combination of (a) and (b);
SSAMB or SSOEB is fixed, in particular is attached to a fixed support;
in it the vertically-average lines of the sides of electromagnet windings to the direction of its relative movement with OEB forms an angle γ, which is limited within the π<γ<0 range;
it comprises at least one AMB, in which the vertically-average lines of the sides of electromagnet windings relative to its base line is located at an angle α, that is limited within the 0<α<π range, wherein vertically-average lines of the sides of electromagnet to the direction of its relative movement with OEB makes an angle γ, which is selected from:

$$α = \frac{π}{2}$$

and α=γ;
in it vertically-average lines constituting the induction-inhomogeneous OEB environment to the direction of its relative movement with the AMB makes an angle α_{μ}, which is limited within the 0<α_{μ}<π range;
in it the lines constituting inductively inhomogeneous OEB environment are curvilinear;
the same inhomogeneities, in particular protrusions, of the two OEBs, located on both sides of AMB are shifted by a half period;
it is configured to allow the equality to zero of the sum of the components of the induction interaction forces acting perpendicular to the direction of motion of the moving SIB part, such as rotational EM hub;
in it each electromagnet is performed separately and into the block they are assembled in a single or in a composed of several parts AMB frame, and they are mechanically attached to at least one form selected from the following group: mechanical hook of electromagnets with the frame; packaging using packaging material such as resin;
in it the mechanical hook of electromagnets with the frame for the open electromagnet type is configured from its upper end face, for the closed electromagnet type is configured from its lower end face;
it is performed allowing the possibility of optimization of curvilinear surface inductive interaction and one of the SSIB (first) nearby the other SSIB (second) border are attached at an intermediate platform or support;
it is configured linear and in it the intermediate platform is connected to the main support formed as a support platform;
it is configured rotational and in it the intermediate platform, through one or more hubs, including the hollow cylinder, is connected to the main support formed as a central support shaft;
its SIB is configured with vertical scanning, wherein one of the SSIB (first) near the other SSIB (second) border is attached to the side support, in the form of one or two sides of the EM body;
its SIB is configured with horizontal scanning, wherein one of the SSIB (first) near the other SSIB (second) border is attached to the side support, in a form of top end side EM body;
it is configured in a form of a plurality of EM, located along the axial direction;
it comprises at least two SSOEBs, formed to allow the possibility to move, particularly to rotate in one of the following ways: independently from each other; co-directionally; in opposite directions;
its body comprises two separable from each other compartments—the compartment for the SIB and the compartment for the main support;
in it the body compartments for SIB include: separable from each other the upper end part C^{M} 11, and two sides C^{M} 21 and C^{M} 22;
it is configured linear and its body compartment for the main support includes a substrate for the supporting platform C^{M} 21;
it is configured rotational and its body compartment for the main support includes two separable from each other C^{M} 31 and C^{M} 32 sides of the body for the SIB, with a central hole in one or two sides of the body for the SIB for the accommodation of the central support shaft;
its induction part has at least one of the types of cooling system: ventilation-air, closed-flowing liquid, closed-evaporating liquid;

Referring now to the drawings, in which same elements, generally indicated only once with numerical references. The present invention may be implemented in many options, and only certain design options, facilitating a better understanding of the proposed technical solutions, will be described through examples, presented schematic drawings.

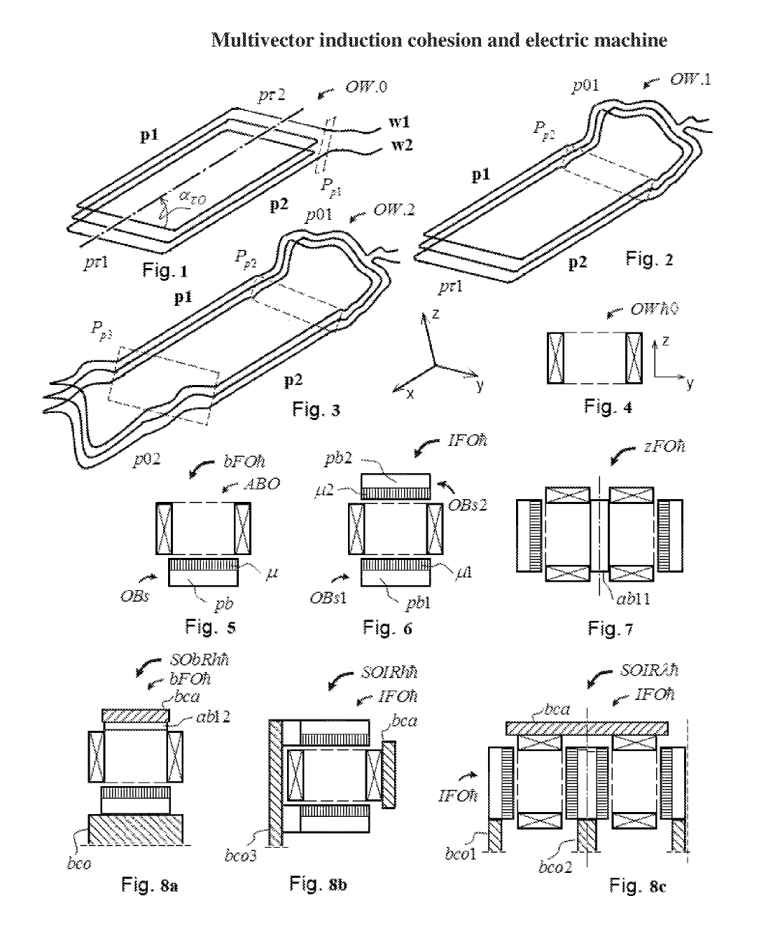

At the present time in the world practice used is one type of electromagnet winding—a single-vector winding OW. FIG. 1-3 shows dimensional images of the well-known OW types: concentrated OW.0, semi-concentrated OW.1 and dispersed OW.2 with the incoming and outgoing parts of w1 w2 winding wiring. Herewith, FIG. 1-3 shows the border of the windings parts areas, involved and not involved in the creation of this winding are divided by planes Pₚⱼ, where j=1, 2, 3. In all of these kinds of OW in the creation of this winding, contribution is only given by the following straight winding areas:
in the concentrated winding OW.0 the creation of this winding involves all four winding parts p1, p2, pτ1 and pτ2;
in the semi-concentrated winding OW.1 the creation of this winding involves three winding parts—p1, p2 and pτ1; winding part p01 may be involved in the creation of other windings;
in the dispersed OW.2 winding the creation of this winding involves two winding parts—p1, p2; the p01 and p02 winding parts may be involved in the development of other windings.

Two sides of the surface between the two lateral p1, p2 parts of the winding form two sides of single-vector winding OW. The two sides of the single-vector winding OW by the side of its transverse parts pτ1 and pτ2 form two sides of the single-vector winding OW.

All known of the single-vector windings are configured so that the vertical center line is disposed at an angle

$${α}_{τ o} = \frac{π}{2}$$

to the bases (to the lines of its transverse parts) pτ1 and pτ2. As it is known, in creating an electromotive power in EM involved are two lateral winding parts—p1 and p2, which are called active winding parts. Transverse parts pτ1 and pτ2, which are called inactive winding parts are not involved in the creation of an electromotive power in EM.

In the future, in relation to any winding the paper will adhere the reporting system of coordinates introduced in the FIG. 1-3 relative to the dimensional orientation of the geometry of the electromagnets windings: the xz-plane of the electromagnets, which is its vertical plane, will be called xz(A)-plane or [symbol] -plane; the zy-plane of the electromagnets, which is its upper plane, will be called zy(A)-plane or ω-plane; the xy-plane of the electromagnets, which is its side plane, will be called the xy(A)-plane or [symbol] -plane. Herewith it is assumed that the main plane of the induction effect of electromagnet winding and the environment is a [symbol] -plane. The distance between the two lateral parts p1 and p2 of the winding is the width of the winding, and the distance between the two transverse parts pτ1 and pτ2 is the height of the winding.

FIG. 4 shows OW in an [symbol] -plane OW [symbol] ⋄.

Known are SIB blocks fractions created on the basis of OW, shown in FIG. 5-7: basic bFO [symbol] , closed IFO [symbol] and z-integrated zFO [symbol] .

Consider the possibilities for disposition/scanning of SIB blocks in EM. Herewith, the vertical EM plane is compatible with said [symbol] -plane (xz-plane of the electromagnets windings). FIG. 8a-8c shows known OW dispositions in EM: SIB of SObRh [symbol] type in EM, comprising basic bFO [symbol] fraction of vertical scanning of the upper AMB side attachment to the EM body, SIB in EM of SOIRh [symbol] type, comprising a closed faction IFO [symbol] of the vertical scanning of AMB side attachment EM to the EM body; group of individual SIBs in the EM of SOIRh [symbol] kind, each of which includes a closed IFO [symbol] fraction of the horizontal scanning of the upper side AMB attachment to the EM body (system comprising a plurality of EM, displaced along their common axial direction).

Known are types of SIB scanning, consisting of two basic fractions or z-integrated fraction (these are shown in the sources mentioned in the bibliography).

FIG. 5-8c also introduce the terms: side OBs, the first side OBs1 and a second side OBs2 of source-off blocks; induction-inhomogeneous environment p, the first induction-inhomogeneous environment μ1, the second induction-inhomogeneous environment μ2, respectively of, the side OBs, the first side OBs1 and a second side OBs2 of source-off blocks; bridge/bus pb, the first bridge/bus pb1, the second bridge/bus pb2 of the magnetic field, respectively of, the side OBs, the first side OBs1 and a second side OBs2 of source-off blocks; the bridges/buses of magnetic fields ab11 and ab12, respectively of, z-integrated fraction zFO [symbol] and an AMB in the EM of SObRh [symbol] kind; the intermediate platforms bco, bco3, bco1, bco2 and for different OBs for SIB, respectively placed in EM of SObRh [symbol] , SOIRh [symbol] and SOIRλ [symbol] kinds; the intermediate platform bca for attachment of AMB to the main support (supporting platform of linear EM or central supporting shaft of the rotary EM) or to the side support (for example, to the EM body); the intermediate platforms bco, bco1 and bco2 for the attachment, respectively of, the side OBs, the first side OBs1 and a second side OBs2 of source-off blocks to the main support or the side support.

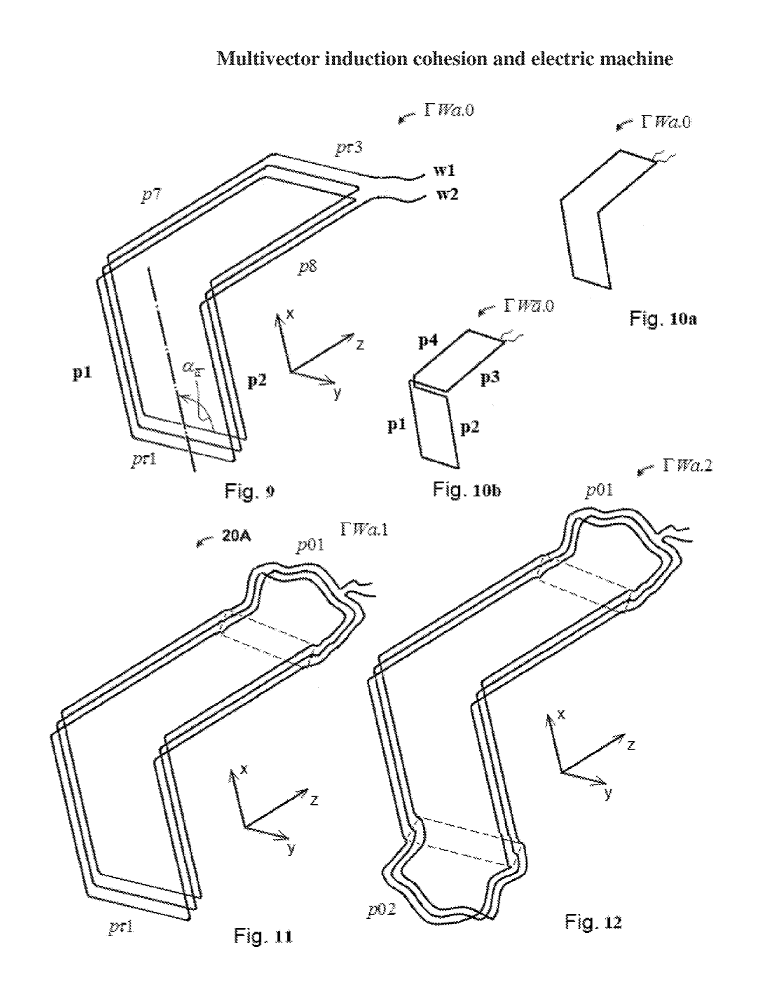

In order to create a high output power of the compact EM the present invention proposes multiple-vector windings for electromagnets. Multiple-vector windings provide the following opportunities: the curvilinear surface induction coupling; high voltage density field per unit volume, in comparison to known single-vector winding for electromagnets; reducing the volume of the winding material. FIG. 9-46 schematically illustrate some examples of performing the types and subtypes of the proposed multiple-vector windings—their formation, symbolic meanings, dimensional orientation in the reporting system of coordinates. Thus, in the Figures multiple-vector windings of electromagnets are configured so that the vertical center line is disposed at an angle

$$\frac{π}{2}$$

(for example, designated are

$${α}_{τ o} = {α}_{τ Γ} = {α}_{τ Λ a} = {α}_{τΛ c} = {α}_{τΛ e} = \frac{π}{2} )$$

In general, any of these angles can be limited within the “more than 0 less than π” range.

FIGS. 9, 11 and 12 show dimensional images of a multiple-vector single-side types (Γ-shaped) winding of electromagnet with incoming and outgoing parts of the winding wire w1 w2: concentrated ΓW.0, semi-concentrated ΓW.1 and dispersed ΓW.2. Herewith the borders of areas of the windings parts, involved and not involved in creation of this winding are divided by planes Pₚⱼ, where j=1, 2, 3. In all of these types of windings, as shown for single-vector winding, the creation of this winding involves only specified straight winding areas.

FIGS. 10a and 10b windings of the multiple-vector single-side winding are presented, for simplicity, in fusion form, respectively, without ΓWa.0 transition to FIG. 10a and anti-symmetrical with the ΓWa.0 transition to FIG. 10b.

Two sides of the surface between the two lateral p1 p2 winding parts form two sides of OW. The two sides of the surface between the two end p7 and p8 parts of the windings form the two end sides of OW. Herewith the angle between the lateral and the end external sides is greater than π, and the angle between the lateral and the end inner sides are less than π. The lower pτ1 and lateral pτ3 transverse parts of Γ-shaped winding are not involved in the creation of an electromotive power of EM.

FIG. 13-22b show examples performing some types of double-sided (Λ-shaped) winding of electromagnet.

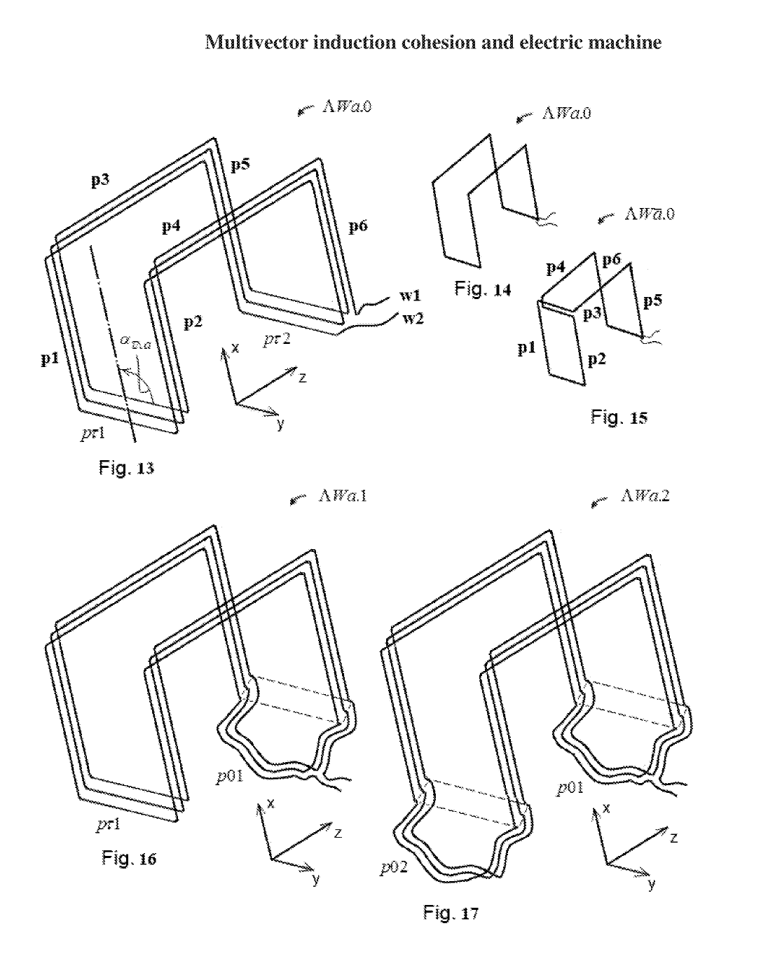

FIGS. 13, 16 and 17 show the dimensional images of multiple-vector types, with a straight upper side parallel to the double-sided winding of the electromagnet with incoming and outgoing parts of the winding wire w1 w2: concentrated ΛWa.0, semi-concentrated ΛWa.1 and dispersed ΛWa.2. Herewith the borders of windings parts areas of involved and not involved in the creation of this winding are divided by planes Pₚⱼ, where j=1, 2, 3. In all of these types of windings, as shown for single-vector winding, in creation of this winding involved are only these straight winding areas. FIGS. 14 and 15 shows that, the windings of multiple-vector double-sided winding, for simplicity, are presented in fusion form, respectively, without transition to FIG. 14 and anti-symmetric with the ΛWā.0 transition to FIG. 15.

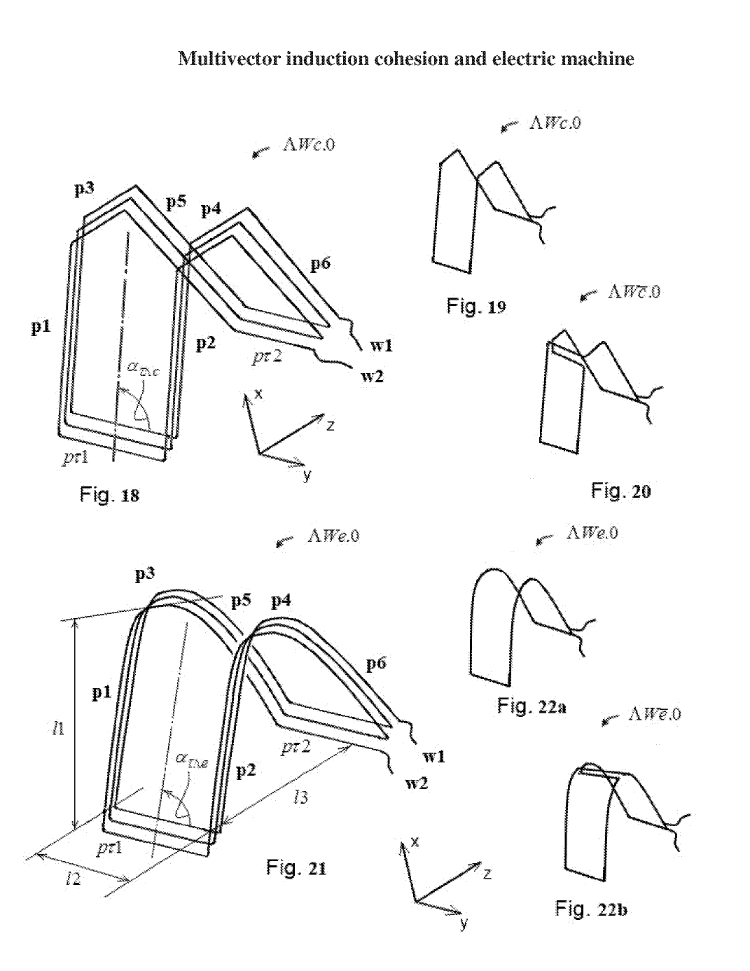

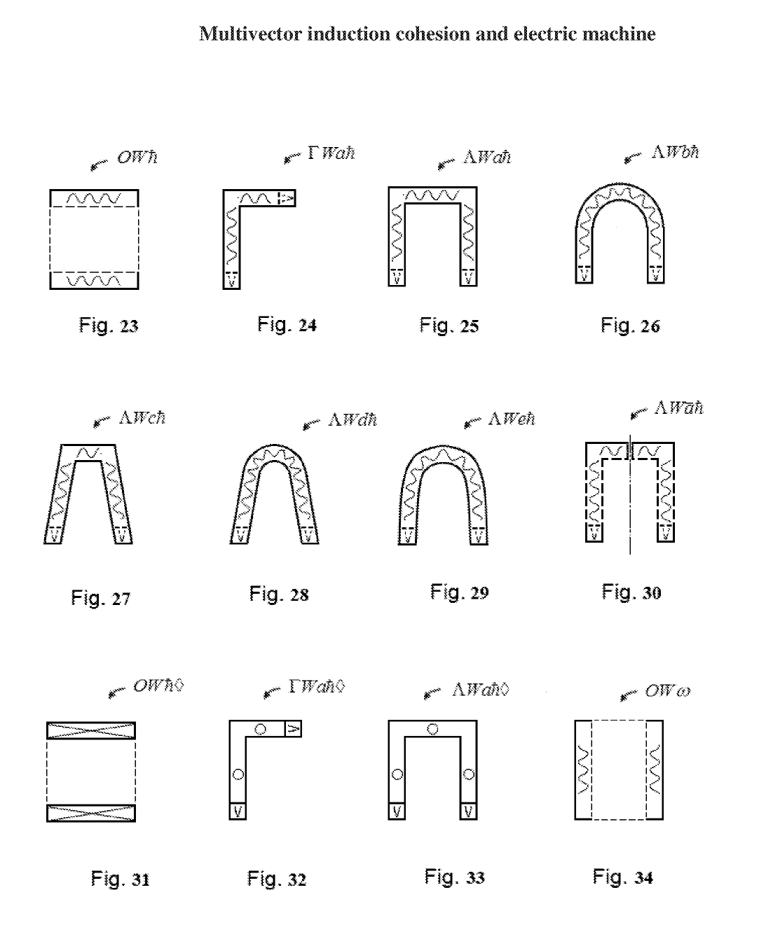

FIGS. 18 and 21 show the dimensional images of further two types: with a straight upper side of the divergent ΛWc.0 and the second order curve ΛWe.0 of concentrated multiple-vector double-sided windings of electromagnets. FIGS. 19 and 20 show that the windings of multiple-vector double-sided winding ΛWc.0 are represented, for simplicity, in fusion form, respectively, without transition to FIG. 19 and anti-symmetrically with transition to FIG. 20. FIGS. 22 and 23 show that the windings of multiple-vector double-sided winding ΛWe.0 are presented, for the simplicity, in fusion form, respectively, without transition to FIG. 22a and anti-symmetrically with ΛWē.0 transition to FIG. 22b.

In all types of double-sided (Λ-shaped) winding of the electromagnet: two sides of the surface between the two lateral parts p1 and p2 of the winding form two sides of the left part of OW; two sides of the surface between the two lateral parts p5 and p6 of the winding form two sides of the right part of OW. The two sides of the surface between the two end p3 and p4 parts of the winding form two end sides of OW. Herewith the angle between the lateral and the end external sides is greater than π, and the angle between the lateral and the end inner sides is smaller than π, FIG. 21 also shows the designations of parameters of Λ-shaped windings: height l1; width l2; the distance l3 between the lower transverse parts of the winding at its base.

The lower transverse parts pτ1 and pτ2 of the Λ-shaped winding are not involved in the creation of an electromotive power of EM. The two sides of the surface between the two lower transverse parts pτ1 and pτ2 of the Λ-shaped winding form its inner and lower side.

FIG. 23-33 show the symbolic forms of the electromagnets windings in the [symbol] -plane. FIG. 23 shows single-vector—OW [symbol] . FIG. 24-30 show multiple-vector: single-sided—ΓWa [symbol] ; with straight upper side parallel double-sided—ΛWa [symbol] ; with semicircular upper side parallel double-sided—ΛWb [symbol] ; with straight upper side diverging double-sided—ΛWc [symbol] ; with sector-circular upper side of the diverging double-sided—ΛWd [symbol] ; double-sided form second order curve type—ΛWe [symbol] ; with straight upper side parallel double-sided anti-symmetric—ΛWā [symbol] . FIG. 31-33 show sections views of the electromagnets windings: single-vector—OW [symbol] ⋄; multiple-vector single-sided—ΓWa [symbol] ⋄; multiple-vector double-sided—ΛWa [symbol] ⋄.

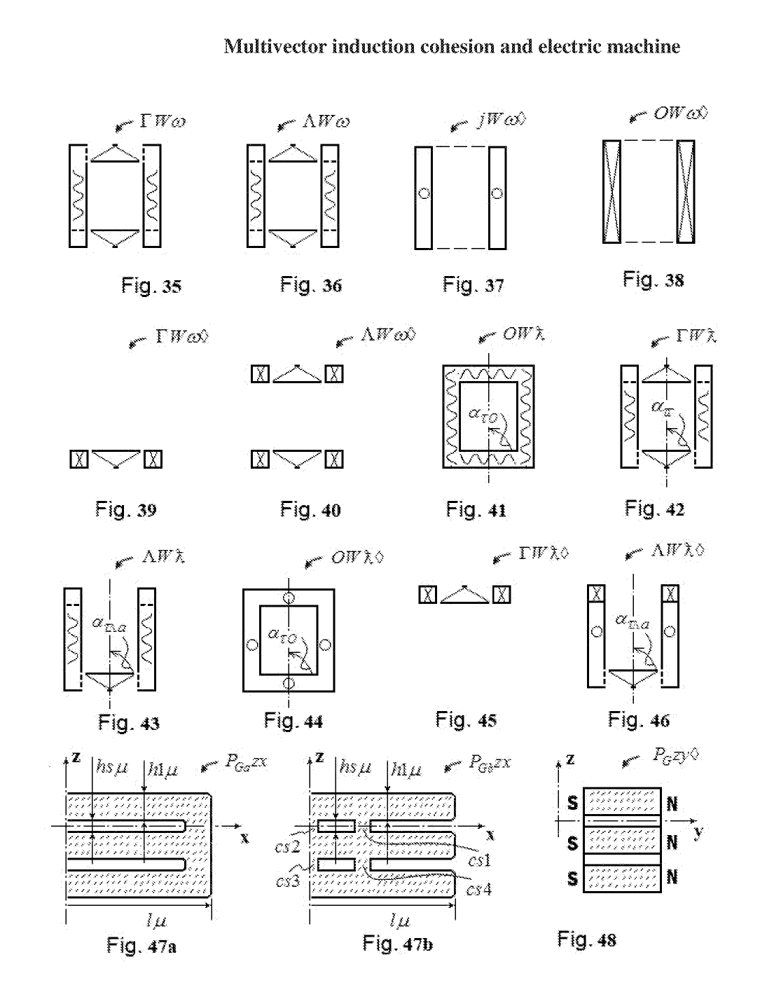

FIG. 34-40 show the symbolic forms of the electromagnets windings in the ω-plane. FIG. 34 shows single-vector—OWω. FIGS. 35 and 36 show: a multiple-vector single-sided—ΓWω; multiple-vector double-sided—ΛWω. FIG. 37-40 show winding sections types: general for any type of winding—jWω⋄, wherein j=O,Γ,Λ; single-vector—OWω⋄; multiple-vector single-sided—ΓWω; multiple-vector double-sided—ΛWω⋄.

FIG. 41-46 show the symbolic types of the electromagnets windings in the [symbol] -plane. FIG. 41 shows single-vector—OW [symbol] . FIGS. 42 and 43 show: multiple-vector single-sided—ΓWa [symbol] ; multiple-vector double-sided—ΛW [symbol] . FIG. 44-46 show electromagnets winding sections types: single-vector—OW [symbol] ⋄; multiple-vector single-sided—ΓW [symbol] ⋄; multiple-vector double-sided—ΛW [symbol] ⋄.

To create a high voltage magnetic field with a small volume and a high resistance to extreme environmental conditions of permanent magnet the present invention proposes using closed-multi-layer P_{G}-type of magnets, and anti-symmetric group of magnets, which enable to create with high voltage and resistance, with a given voltage direction of the magnetic field in the dimension. FIG. 47-58 show some examples of performing the types of the proposed closed-multi-layer P_{G}-type of magnet, and anti-symmetric group of magnets—their formations, symbolic designations, dimensional orientation in the reporting system of coordinates.

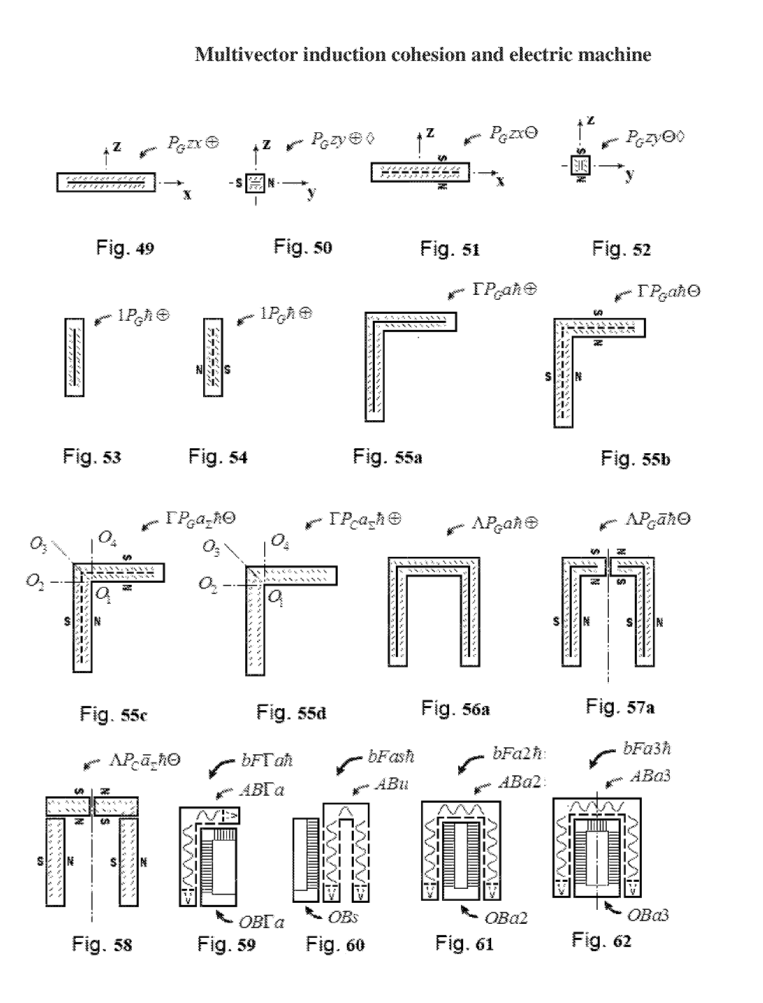

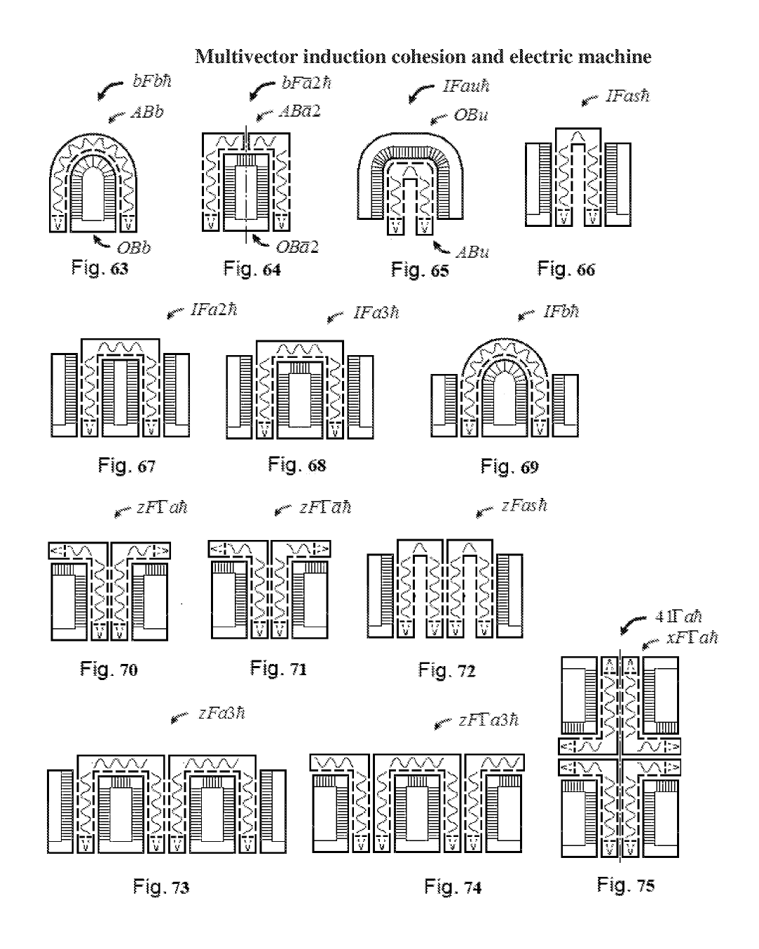

FIGS. 47a, 47b and 48 show two types of closed-multi-layer P_{G}-type magnet, with a particular case, when the magnet has a total of three layers and they are straight. Of course they may contain two or more than three layers, and may also also be curved. In any case: the width of the gap between layers is small hsμ→0, the layer thickness is less than its length h1μ [symbol] lμ.

FIGS. 47a and 47b show the two types of closed-multi-layer P_{G}-type of magnet in the longitudinal vertical plane, respectively closed at the edges P_{Ga}zx type and a closed through jumper P_{Gb}zx type. FIG. 47b shows that: the layers are closed through four jumpers cs1, cs2, cs3 and cs4; doubly-symmetric relative the two planes—coordinate zy-plane and geometric mean plane, parallel to the coordinate xy-plane. In general, these conditions are not required—the number of jumpers and dimensional configurations can be arbitrary. FIG. 48 shows P_{G}-type of magnet in the section of transverse-vertical plane.

FIG. 49-52, in said two inter-perpendicular planes zx and zy, show the symbolic designations of P_{G}-type of magnet: symbolic designations in FIGS. 49 and 50 correspond the magnet positions shown in FIGS. 47 and 48; symbolic designations in FIGS. 51 and 52 of correspond the magnet positions, when the coordinate of plane zx is parallel to the longitudinal horizontal plane of the magnet.

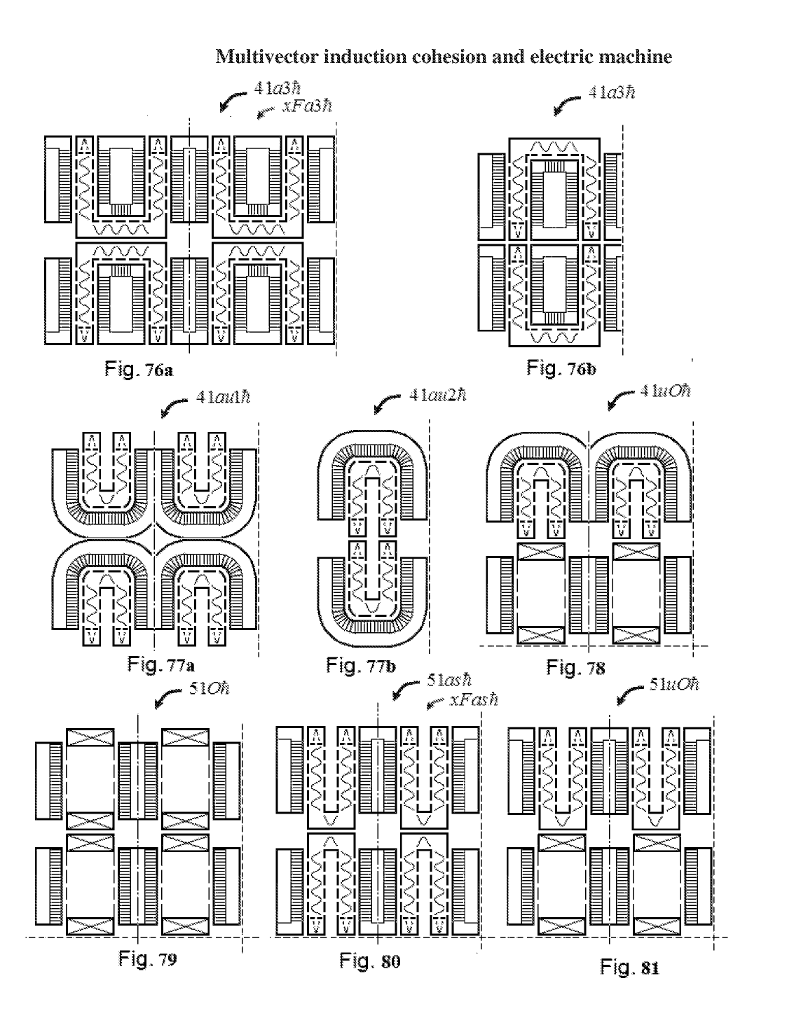

FIG. 53-58, in said [symbol] -plane (xz-plane of electromagnets windings) show some symbolic designation of the geometry of the P_{G}-type magnet and anti-symmetric group of magnets formation. FIGS. 53 and 54 show symbolic designations of magnets shown in the FIGS. 49 and 51, respectively, directed by the (towards us) unipolar side 1P [symbol] ⊕ and by the bipolar side 1P [symbol] Θ. FIGS. 55a and 55b show multiple-vector single-sided magnets, respectively, directed by the unipolar side ΓP_{G}a [symbol] ⊕ and by the bipolar side ΓP_{G}a [symbol] Θ. FIG. 55c and 55d show respectively multiple-vector single-sided magnet directed by bipolar side ΓP_{G}a_{Σ} [symbol] Θ and consisting of two not layered magnets ΓP_{C}a_{Σ} [symbol] ⊕, which consist of two parts, separated by any of the planes O₁O₂, O₁O₃ and O₁O₄. FIG. 56a shows directed by unipolar side multiple-vector double-sided magnet ΛP_{G}a [symbol] ⊕. Of course at the multiple-vector double-sided magnets can also be such a variety, as we have shown for the multiple-vector single-sided magnets. FIG. 57a and 58 show multiple-vector double-sided magnets, each of which is an anti-symmetric group of magnets: ΛP_{G}ā [symbol] Θ—consisting of two ΓP_{G}a [symbol] ⊕-types of magnets; ΛP_{C}ā_{Σ} [symbol] Θ—consisting of four not layered magnets.

FIG. 59-81, in said [symbol] -plane (xz-plane of electromagnets windings) in symbolic designations show some of the possibilities of forming kinds of block structure (interposition principles of various types of inducing blocks) in SIB. The block structure of SIB conditionally it is possible to distinguish at least one of the blocks fractions: basic SIB fraction; closed SIB fraction; Z z-integrated SIB fraction; X x-integrated SIB fraction. Herewith the nature of blocks dimensional disposition the multi-block SIBs are divided into: single-row structure, double-row structure, multi-row structure.

The lateral, end and lower sides of the basic, closed SIB factions and the electromagnetic block, will be assumed as the appropriate sides of the electromagnet winding.

Note that in the figures: the dashed lines with dots are axes of symmetry; short-dashed lines indicate that the image chain is broken, and it can be continued same as the pictures shown.

The basic fraction is formed by electromagnetic block, created on the basis of the chain of one of the winding types mentioned in the FIG. 23-30, and docked with it non-source block. FIG. 59-64 show the basic SIB fractions bFΓa [symbol] , bFas [symbol] , bFa2 [symbol] , bFa3 [symbol] , bFb [symbol] and bFā2 [symbol] , which are formed, respectively, by electromagnetic blocks ABΓa, ABu, ABa2, ABa3, ABb and ABā2 when docking the appropriate them non-source blocks to them: the internal OBΓa; side OBs; internal OBa2, OBa3, OBb and OBā2. All electromagnetic blocks, except for the closed electromagnetic block ABu, and a single-vector electromagnetic block ABO, are open. In the closed electromagnetic block ABu the distance between the sides is made small and without the possibility of placing the non-source OEB block there.

Closed factions are formed by additional docking of the non-source blocks elements to the basic fractions, wherein only one side of the electromagnetic block remains open. Some of the closed SIB fractions are shown in FIG. 65-69: IFau [symbol] , IFas [symbol] , IFa2 [symbol] , IFa3 [symbol] and IFb [symbol] . In closed factions the certain exception is IFau [symbol] that is formed by the docking of closed electromagnetic block ABu with semicircular non-source block OBu.

Non-source OEB blocks, as already noted, are divided into lateral non-source OBs blocks and into non lateral non-source blocks: internal OBΓa; internal OBa2, OBa3, OBb, and OBā2; semicircle OBu.

z-integrated SIB fraction is formed by docking of the two electromagnetic blocks of basic fraction by the sides of its AMB, wherein z-integrated SIB fraction may further comprise one or more non-source blocks. Some of the examples of forming z-integrated SIB fraction are shown in FIG. 70-74:

x-integrated SIB fraction is formed by docking of the two electromagnetic blocks of basic fractions by its active (in creating electromotive power in EM) end side. Herewith x-integrated SIB fraction may further comprise one or more non-source blocks. Some examples of formation of x-integrated SIB fraction are shown in FIGS. 75, 76a and 80, respectively, xFΓa [symbol] , xFa3 [symbol] and xFas [symbol] as part of multi-block SIB structures.

Single-row SIB structures include at least two electromagnetic blocks, and any of them can be formed on the basis of selecting from a plurality of said basic, closed and z-integrated SIB fractions, docking them between each other at the sides.

Double-row SIB structures as shown in the example in FIG. 75-81, can be formed from two single-row SIB structures. At least three-row SIB structures is expedient, for the workability of assembly and repair, to form with the OEB, configured in a lateral type of OBs, as shown by way of example in FIG. 79-81, or in the form of a OEB, configured in a lateral OBs type in all rows, except one of the outer rows, as shown, by way of example, in FIG. 78.

These Figures show not all possible options of SIB structure forming, but we have given the principles of their construction and it is not difficult for specialists to continue building and further, based on and on the analogs of the given examples. For example, in FIGS. 78 and 81 the upper rows of the blocks can be rotated vertically; in FIG. 80 one of the rows or both rows of blocks can be rotated vertically. When docking structural fractions the sides of two adjacent OEBs in FIG. 76a, 77a, 78-81 are attached (configured together), but in any of such structures they may be docked separately (placed closely) and may also be movable relative to each other.

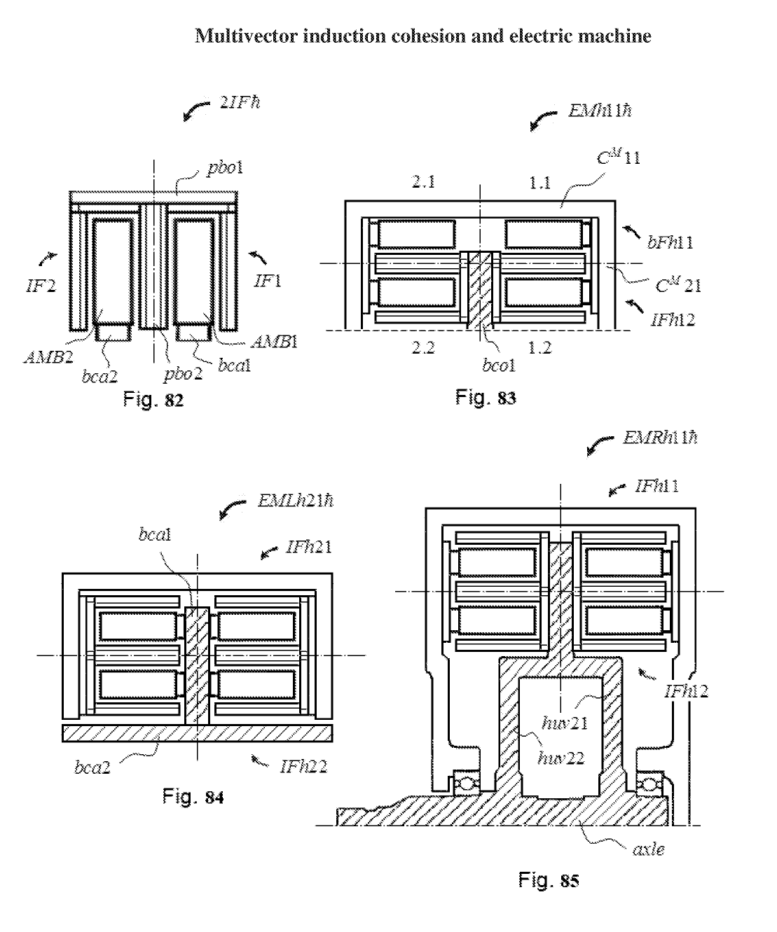

FIG. 82, in [symbol] -plane schematically shows the principle of association (attachment) of two closed factions IF1 and IF2 in SIB between each other through common magnet-conductive bridges pbo1 and pbo2. Herewith the electromagnetic blocks AMB1 and AMB2 have separate intermediate platforms pbo1 and pbo2, respectively, for attaching them to a common support. Electromagnetic blocks, in this case AMB1 and AMB2, together, form SSAMB, the remaining SIB part forms SSOEB.

Consider the possibility of placing and scanning SIB blocks in EM. Herewith, as already mentioned, the vertical EM plane is compatible with said [symbol] -plane (xz-plane of the electromagnets windings).

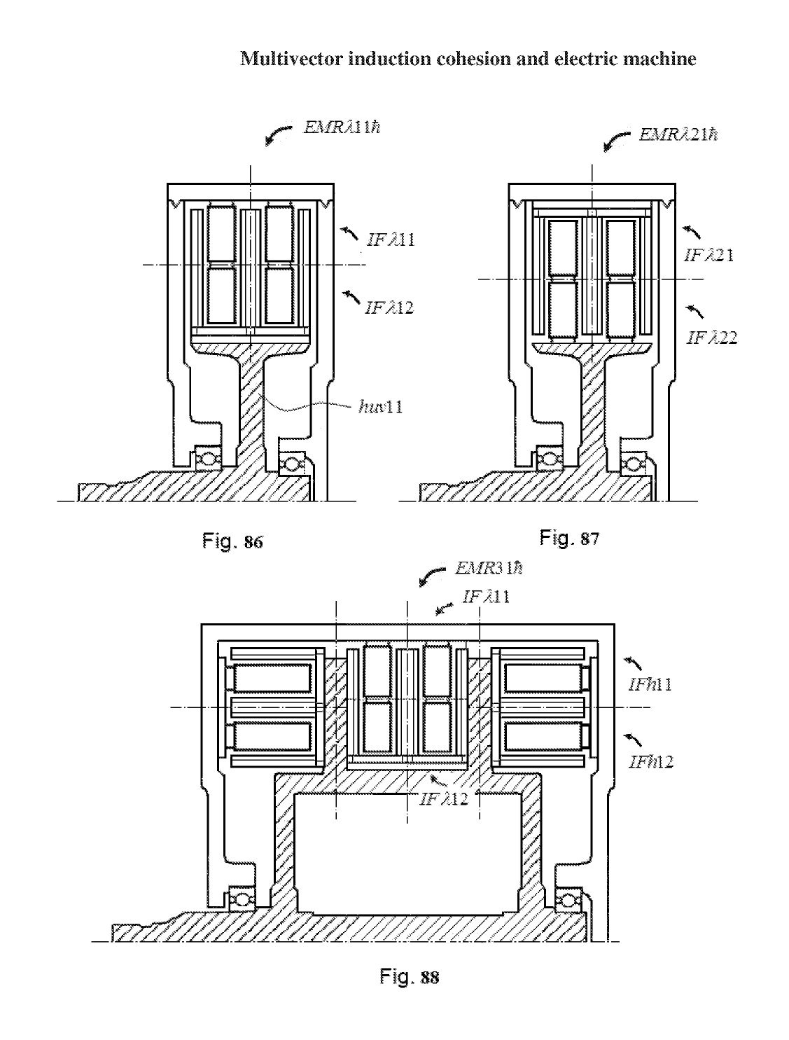

FIG. 83-88, on the basis of the representation in FIG. 82, show some of the types of scanning of SIB blocks: FIG. 83-85 show a vertical scan ( [symbol] -scanning) of SIB blocks with lateral attachment of one of the SSIB; FIGS. 86 and 87 show a horizontal scan (λ-scanning) of SIB blocks with upper end attachment of one of the SSIB; FIG. 88 shows a mixed SIB block scanning with its mixed attachment.

FIG. 83-88 by the intersecting point-dotted lines the SIB areas are divided into four (FIG. 83-87) or in to eight quadrants (FIG. 88), each of which comprises a basic fraction or a closed fraction. Herewith any SIB area is symmetrical relative to a central vertical point-dotted line, and therefore, designations of SIB components are introduced only one of the symmetrical SIB parts.

FIG. 83 comprises a base fraction bFh11 and a closed fraction IFh21. On the basis of FIG. 83 shown are some of the rules that adheres to all of FIG. 83-87:
quadrants numbering is carried out on the column of the right hand, for example, and thereafter;
shown types of SIB attachments apply for any kind of linear and rotational EM-SSOEB—intermediate platform bco1 can be attached to the main support (to the central support shaft of rotational EM or reference platform of linear EM);
at the lateral SSIB attaching the one of the SSIB is attached at least to one side C^{M} 21 and C^{M} 22 of the body, wherein the upper end side C^{M} 11 of the body may be free.

FIG. 84 shows a linear EM EMLh21 [symbol] , in which the sides of the body attached are SSOEB. Herewith, the SSAMB through an intermediate platform bca1 is attached to the support platform (base) bca2 of the linear EM.

FIG. 85-88 show rotational EM, respectively, EMRh11 [symbol] , EMRλ11 [symbol] , EMRλ21 [symbol] and EMR31 [symbol] types, in which one of the subsystems of SSIB blocks near the border of other SSIB are attached to the intermediate platform, which is through one hub huv11, for example, such as in EMRλ11 [symbol] , EMRλ21 [symbol] , or more hubs, for example, such as in EMRh11 [symbol] EMR31 [symbol] through two hubs, huv21 and huv22, is connected to the central shaft axle. The number of hubs is not critical, and will not depend on the mechanical rigidity of the requirements of the EM components.

FIG. 85 shows the attached SSAMB to the upper side of the body. Wherein SSOEB is attached to the central support shaft axle.

FIG. 86 shows the attached SSAMB to the upper end side of the body. Wherein SSOEB is attached to the central support shaft axle.

FIG. 87 shows the attached SSOEB to the upper end side of the body. Wherein SSAMB attached to the central support shaft axle.

FIG. 88: out of eight SSAMB blocks fractions four are attached to the upper end side of the body, and the remaining four are attached to the sides of the body; SSOEB is attached to the central support shaft axle.

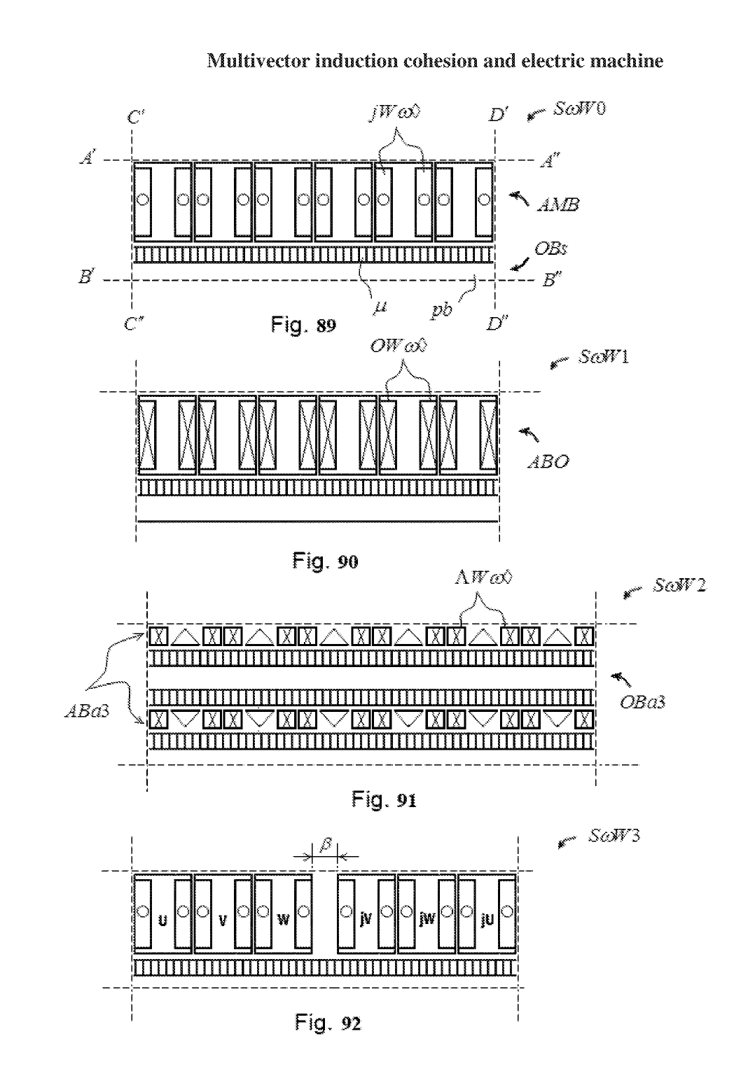

FIG. 89-95, 107-117 in the ω-plane in the symbolic designations show principles of the internal structures of the AMB and the OEB in SIB.

FIG. 89 shows the SIB sector, interrupted on all four sides by broken lines, within the frames of which the internal structures of blocks will be considered. Herewith the designations are introduced: AMB electromagnet block; general form of the section for any type of electromagnet windings jWω⋄, wherein j=O,Γ,Λ; side non-source block OBs; induction-inhomogeneous environment μ; bridge/bus of magnetic field pb. As noted regarding FIG. 59-81, the final designs of types of the block structure forming (principles of relative position of different kinds of interacting blocks) in SIB may be varied. Of course, in the special case the winding section must confirm to one of the analogues shown in FIG. 38-40. To demonstrate this, in FIGS. 90 and 91 shown are, respectively: single-vector winding ABO in the section OWω⋄; multiple-vector winding ABa3 in the section ΛWω⋄. Herewith the SωW2 sector of the SIB systems has an additional block—internal non-source block of OBa3 type.

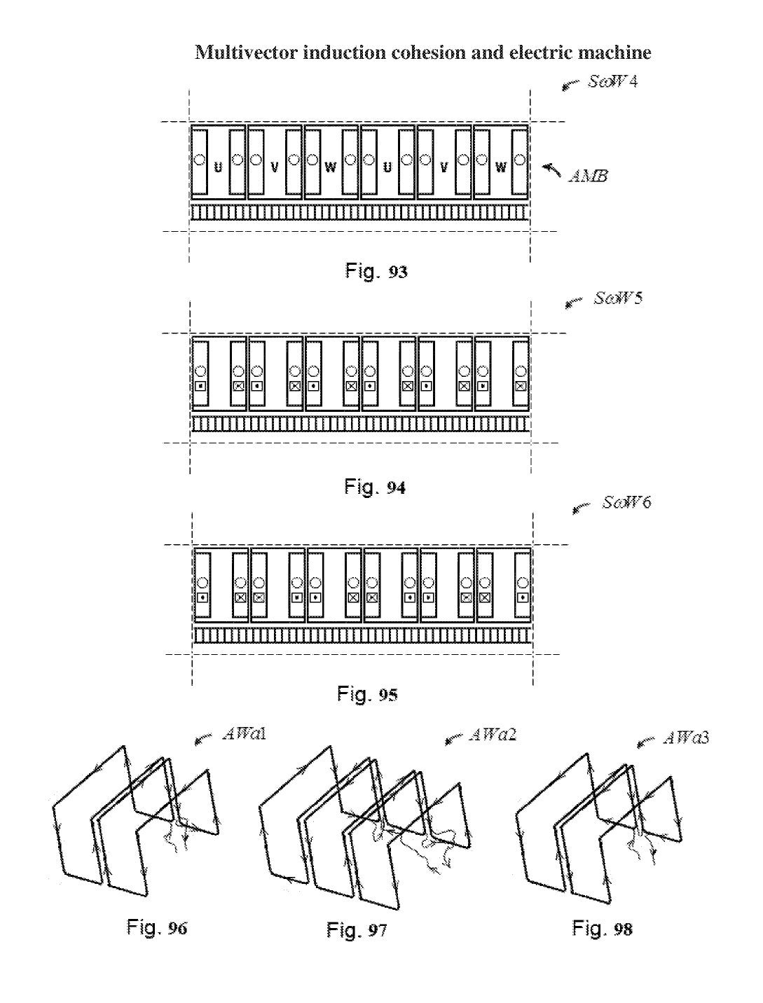

FIG. 92-106 show some of the features of electromagnets windings as part of SIB system.

FIG. 92 shows a SIB sector SωW3 with ternary winding electromagnets ensembles. Herewith the block of ternary electromagnets ensembles have a period of two groups of electrical phases U V W and /U /V /W, in which the difference of electrical phases from each other is β. Note that a block may consist of several separated from each other parts, and two groups of electrical phases U V W and /U /V /W may be located in different parts of the block. As mentioned in the review of sources, for example, in U.S. Pat. No. 8,624,446, and US 20130076159 A1 the discussed winding options can be transferred to the proposed contact SSAMB.

FIG. 93 shows a single AMB block for the three-phase amperage. FIGS. 94 and 95, respectively show the case of anti-parallel and antiparallel amperages of unilocular parts of two adjacent windings.

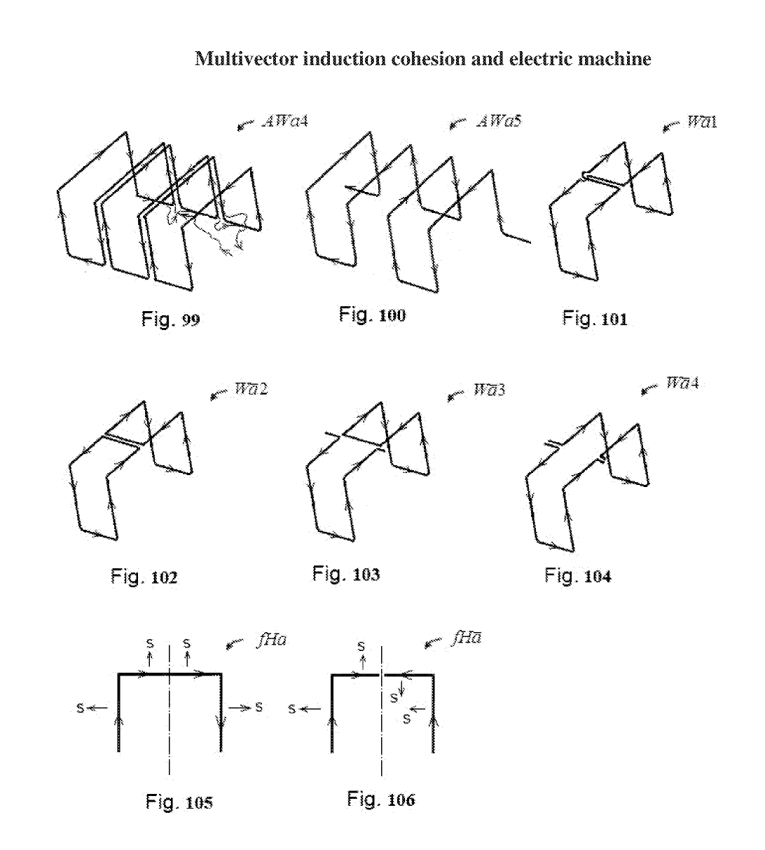

FIG. 96-106, show some examples of the multiple-vector double-sided windings. FIG. 96-99 show the options of ensuring the implementation of parallel (FIGS. 96 and 97) and antiparallel (FIGS. 98 and 99) amperages in unilocular parts of two adjacent windings at one pair of input and output of windings for two or three winding ensembles. FIG. 100 shows an example of semi-concentrated winding. FIG. 101-104 show examples of performing the docking of the two parts of the multiple-vector double-sided anti-symmetric windings. FIGS. 105 and 106 show the orientation of the magnetic field vectors at different parts of the winding, respectively, for the symmetric and anti-symmetric windings.

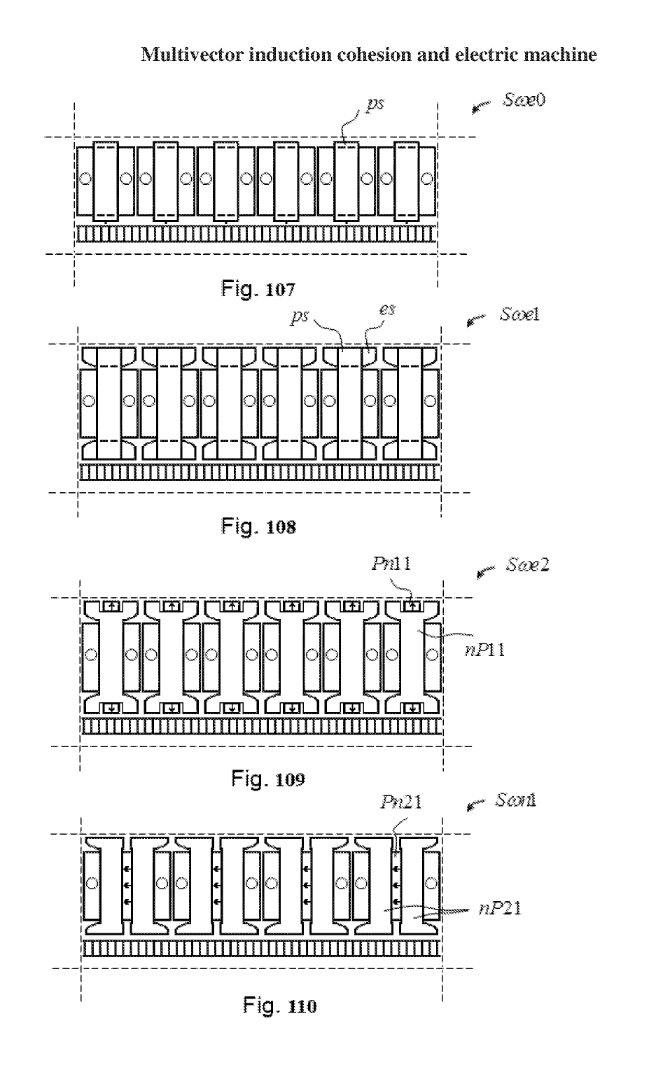

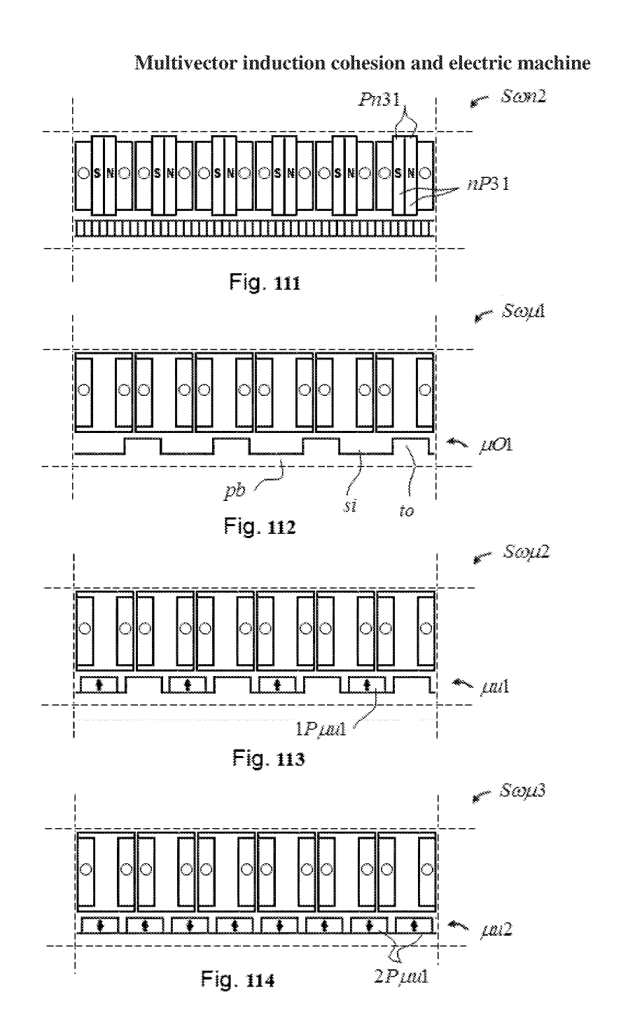

FIG. 107-111 show the options of performing the cores of the electromagnets. FIG. 107 shows the cores ps of the electromagnets quadrangular caps/cogs. FIG. 108 shows the cores caps of the electromagnets with removable shoes es. The shoes may not be removable. FIG. 109 shows the shoes of the electromagnets with the permanent magnets Pn11 displaced on them. Herewith there may be several permanent magnets on each shoe. FIG. 110 shows a core nP21 consisting of two parts, between which a magnet Pn21 is placed. FIG. 111 shows a core Pn31 configured in the form of two magnets.

FIG. 112-117 show types of OEB execution, in which the magnetic bridges/buses pb and heterogeneities of inductive interaction includes magnet-soft materials. FIG. 112 shows the heterogeneity of the inductive interaction μO1, performed in the form of periodically displaced cogs to and cavities si in the magnet-soft material. FIG. 113 shows heterogeneity of inductive interaction μu1, which in contrast to FIG. 112, in the cavities si further displaced are single-directed permanent magnets 1Pμu1. FIG. 114 shows the heterogeneity of inductive interaction μu2, performed in the form of periodically displaced multi-directional permanent magnets 2Pμu1.

It is known that the surfaces of the OEB, addressed to the AMB, can have a constant curvature or periodically variable curvature. Herewith the permanent magnets may be configured on the surface or in a pocket, or partially in the pocket of the bridge/bus from magnet-soft material.

FIG. 115a shows heterogeneity of inductive interaction μi10 with the permanent magnets of Pμ10 type, partially performing in a pocket of magnet-soft material. Herewith, as in FIG. 115b-117, the surfaces s0 of the OEB, addressed to the AMB, have a periodic variable curvature (petal-shaped). Note that at least one of the parts 101 and 102 of the permanent magnet Pμ10 may be absent, in particular it may instead be an air layer.

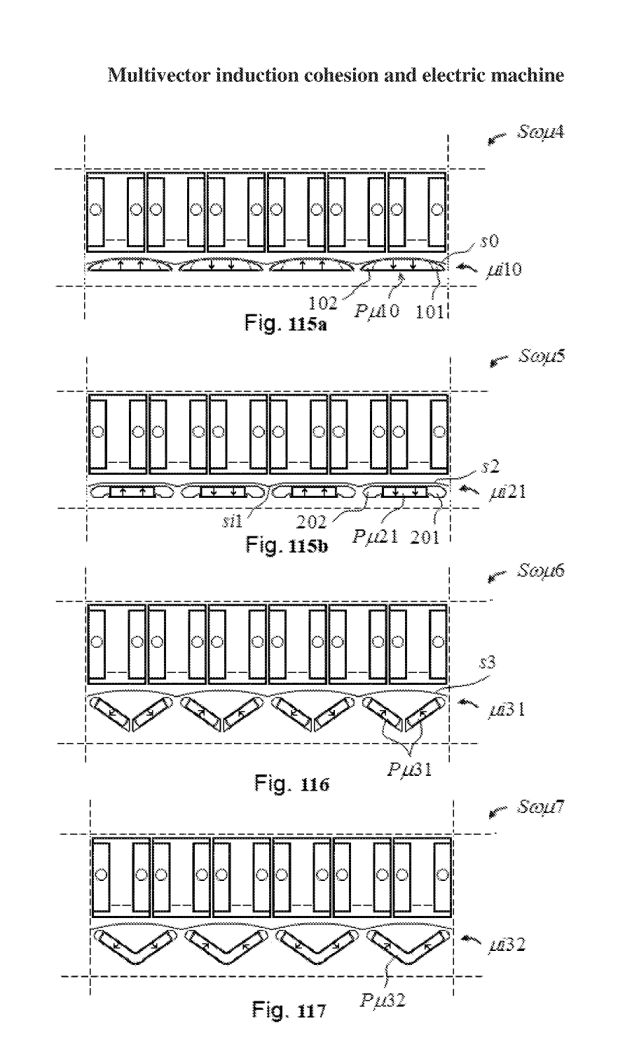

FIG. 115b-117 show the types of performing OEB, in which permanent magnets are displaced in the pockets of bridge-bus from the magnet-soft material. FIG. 115b shows the heterogeneity of the inductive interaction μi21, which includes periodically displaced multi-directional permanent magnets Pμ21. Herewith the surfaces s2 of OEB, addressed to AMB, is performed flat and at least on one side of each magnet Pμ21 there is a recess si1 and an air bag 201. FIGS. 116 and 117, respectively, show the types of configuring inhomogeneities of inductive interaction, in which a magnetic pole is formed, respectively: by the composition of several magnets Pμ31 and Pμ32; curved permanent magnet Pμ32. Herewith the surface s3 of the non-source OEB block, addressed to the electromagnetic AMB block is performed periodically to the variable curvature (petal-shaped).

Let us turn to the possibility of the multiple-vector armature windings, including cores and shoes) blocks for multiple-vector single-sided (Γ-shaped) electromagnet winding and various types of multiple-vector double-sided (Λ-shaped) electromagnet winding shown in FIG. 24-30. All of them, except a closed type electromagnet, which can be included in the closed-type electromagnetic block ABu, in particular indicated in FIGS. 60 and 65, may be performed on a single principle. Types of double-sided (Λ-shaped) armatures differ from one another by their common form, in accordance with the form of said forms of the electromagnet windings types. Armature of single-sided (Γ-shaped) electromagnet winding can be configured as a half double-sided (Λ-shaped) armature.

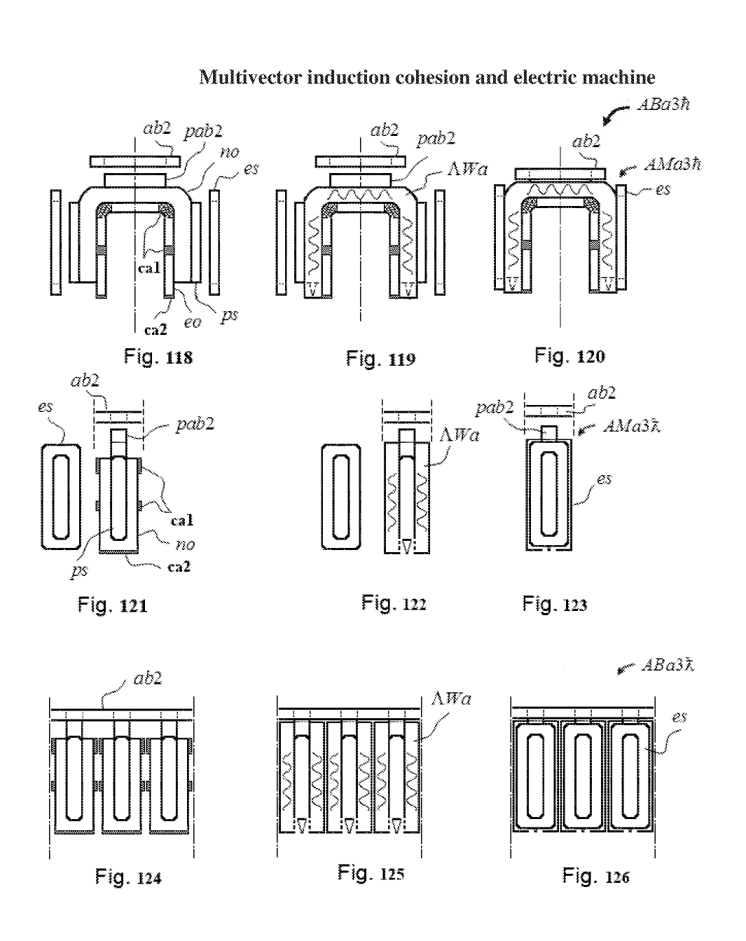

The possibility of constructing a multiple-vector double-sided types (Λ-shaped) of armature and on its basis of multiple-vector electromagnetic blocks and SIB fractions will be shown on the example of the analysis of the electromagnetic blocks implementation: open type electromagnetic block ABa3 and in its composition an open type electromagnet AMa3 in FIG. 118-126; closed type electromagnetic block ABu2 [symbol] and in its composition a closed type electromagnet ABu in FIG. 127-133.

FIG. 118-120 show an open type electromagnetic block ABa3 and in its structure an open type electromagnet AMa3 in projection on [symbol] -plane of EM. FIG. 118 shows electromagnetic block ABa3 without winding and in a disassembled view, which shows: the magnetic bridge/bus ab2 of electromagnet and for its landing cap/cog pab2; kernel/core of winding no; side electromagnet shoe es and for its planting cap/cog ps; inner shoe eo; additional side directing limiters ca1 and the lower directing limiter ca2 of electromagnet winding. FIG. 119 shows the same as that in FIG. 118, but includes an ΛWa electromagnet winding. FIG. 120 shows the electromagnetic block ABa3h assembled. FIG. 120 shows all the components, except the external magnetic bridge/bus of ab2 electromagnet and cap/cog for planting pab2, relate to the electromagnet AMa3h.

FIG. 121-126 show sector of the block ABa3 and in its composition electromagnet AMa3 in projection on [symbol] -plane of EM. FIGS. 121 and 122 correspond to FIGS. 118 and 119, but are shown in [symbol] -plane. FIG. 123 shows the same as FIG. 120, but is presented in [symbol] -plane and the magnetic bridge/bus electromagnet ab2 shown separately from the electromagnet AMa3 [symbol] . FIG. 124-126 show a ABa3 [symbol] block sector: FIG. 124 shows—without shoe es and winding ΛWa; FIG. 125 shows—without shoe es; FIG. 126 shows—ABa3 [symbol] in full. It should be noted that the additional lateral directional limiters ca1 and ca2 of the electromagnetic winding can be made solid, and made of a magnetic insulation material.

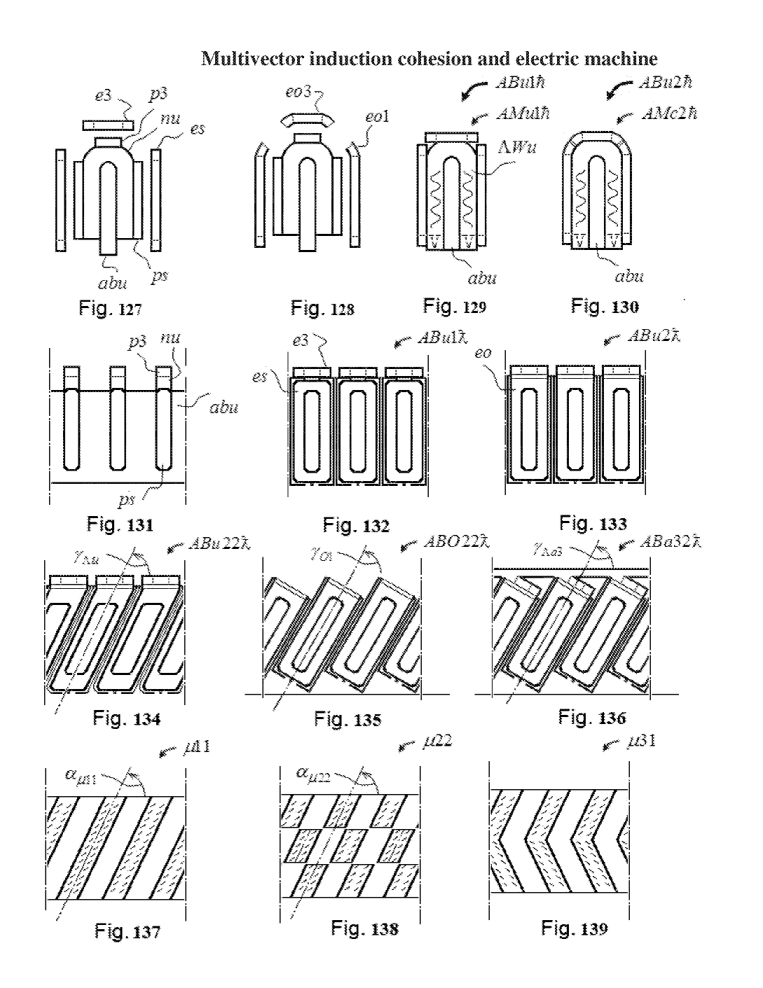

We turn to the question of the possible implementation of a closed type electromagnet. FIG. 127-130 show closed type electromagnetic block ABu2 [symbol] and it includes a closed type electromagnet ABu in projection on [symbol] -plane of EM. FIG. 127 shows electromagnetic block ABu without winding and in a disassembled view, which shows: the internal magnetic bridge/tire electromagnet abu; kernel/core of the winding nu; side flat electromagnet shoe es and for its planting cap/cog ps; upper flat electromagnet shoe e3 and for its planting cap/cog p3. FIG. 128 shows the same as that in FIG. 127, but at least one of the side shoe eo1 of electromagnet and the upper shoe eo3 of electromagnet are configured in a curved form. FIGS. 129 and 130 correspond to FIGS. 127 and 128, but include winding ΛWu and are shown in assembled form as two electromagnetic blocks ABu1 [symbol] and ABu2 [symbol] , accordingly, with external flat shoes and with external curved shoes, which comprise a magnetic bridge/bus abu of electromagnet, respectively, closed type electromagnets of AMu1 [symbol] and AMu2 [symbol] type.

FIG. 131-133 show in projection on EM [symbol] -plane sectors of closed type electromagnetic blocks ABu1 [symbol] and ABu2 [symbol] : FIG. 131 shows—without shoes ps and without winding ΛWu; FIGS. 132 and 133 show, respectively, the sectors of closed type electromagnetic blocks with flat shoes ABu1 [symbol] and with curved shoes ABu2 [symbol] in its entire composition.

FIG. 121-133 shows AMB sectors in which vertical-center lines of the lateral sides of the winding and the shoe of the electromagnet are perpendicular to the direction of their relative movement with OEB. In general, the vertical-center lines of the lateral sides of the winding and the shoe of the electromagnet can make towards the direction of its relative motion with OEB an angle γ different from the

$$\frac{π}{2} .$$

Some examples implementation of such options of the AMB are shown in FIG. 134-136, where the angles γ_{Λu}, γ_{O1}, γ_{Λa3} correspond to said γ angle location to the relative motion for: AMu22 [symbol] , which is an analog to an oblique position relative to the said perpendicular sector of closed type electromagnetic block AMu2 [symbol] ; ABO22 [symbol] , which is an analog to an oblique position relative to perpendicular position of the said sector of single-vector type of electromagnetic block AMO1 [symbol] ; AMa32 [symbol] , which is an analog to the oblique position relative to the perpendicular position of the said sector of open type of electromagnetic block AMa3 [symbol] .

FIG. 137-139 show the OEB sectors μ11, μ22, in which vertical-center lines composing inductive-inhomogeneous environment towards the direction of its relative movement with AMB, form, respectively, the angles α_{μ11}, α_{μ22}, as well as the OEB sector, the inductive-inhomogeneous environment components of which are curved. In the particular case it may be, that the

$${α}_{μ 11} = \frac{π}{2} , {α}_{μ 22} = \frac{π}{2} .$$

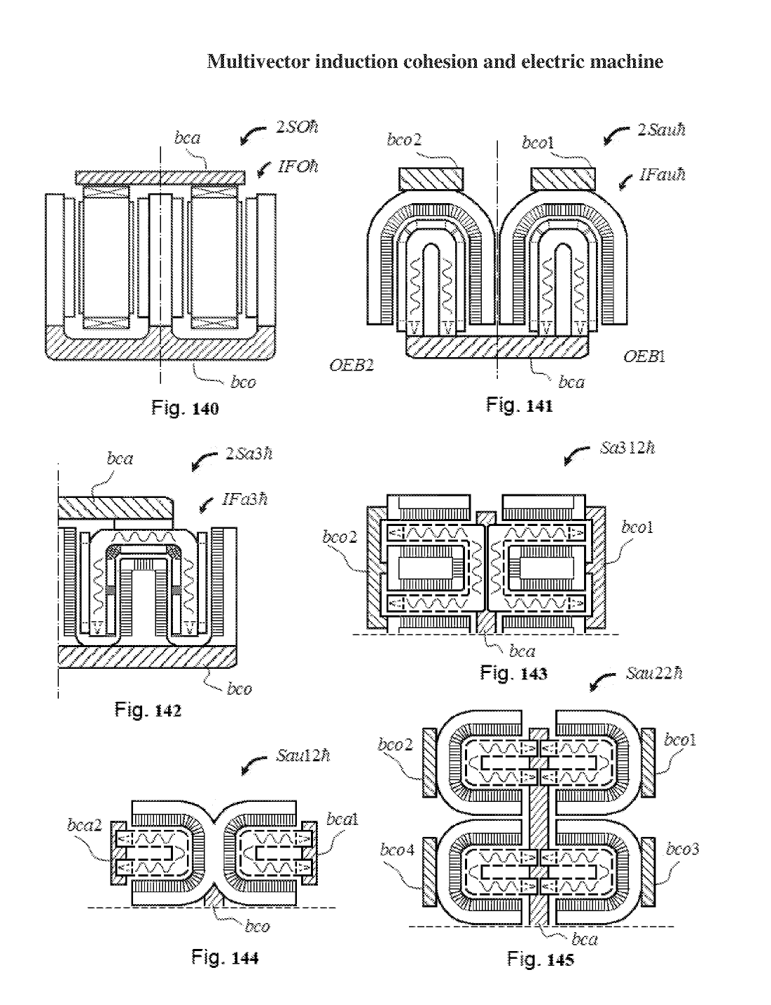

FIG. 140-146, based on the shown FIG. 59-88, show a number of principles of blocks disposition in EM depending on the types of blocks. Herewith introduced are the designations: bca, bca1, bca2 are intermediate platforms to connect the electromagnetic blocks to their supports; bco, bco1, bco2, bco3 and bco4 are intermediate platforms to connect non-source blocks to their supports.

FIG. 140-142 show single-row chains of closed fractions respectively, IFO [symbol] , IFau [symbol] , IFa3 [symbol] with indication of their intermediate platforms bca, bco, bco1 and bco2 for connecting them to docking supports in EM. Single-row chain can consist of at least two combined at the lateral sides basic and/or closed SIB fractions. Herewith, in any of them, the adjacent OEB1 and OEB2 may be configured together, as shown in FIG. 140, or separately, as shown in FIG. 141.

FIG. 143-145 show possibilities of attachment of blocks in EM for double-row SIB structures, shown in FIG. 75-77b. Any of such structures in EM can be placed as vertical scanning and appropriately, in order to ensure that joining areas of blocks to each other (FIGS. 143 and 145 show intermediate platforms bca, and FIG. 144 shows intermediate platform bco) can be attached to the main support of EM. Herewith FIG. 145 shows intermediate platforms bco1 and bco2 can be attached to the one side support, and the intermediate platforms bco3 and bco4 to the other side support, allowing them to move independently, such as spinning in different directions.

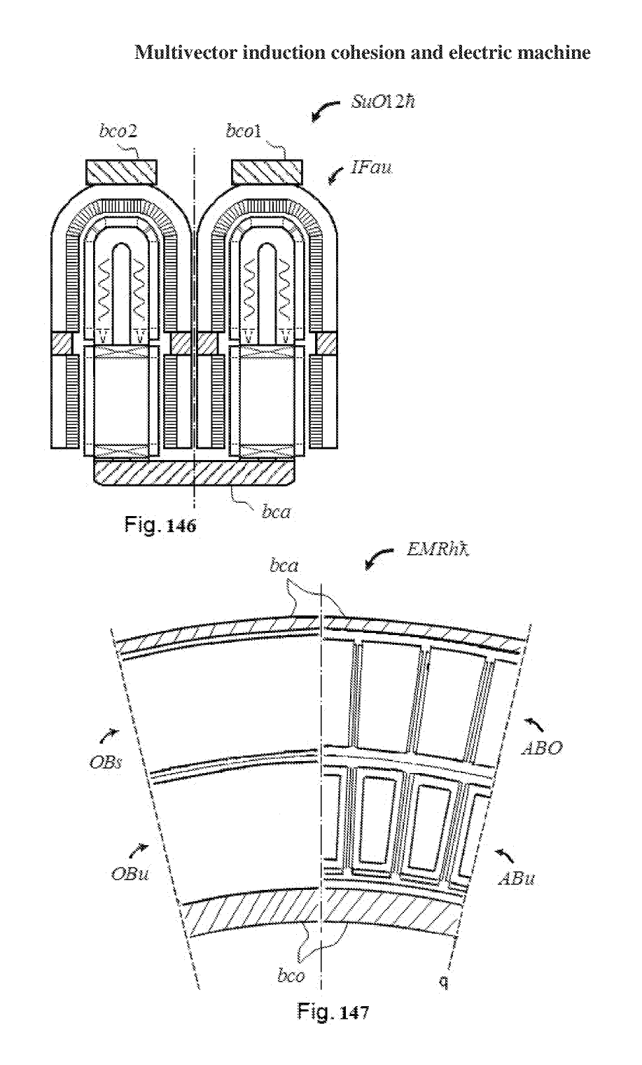

FIG. 146, on the basis of mentioned SIB structure in FIG. 78, shows the options to attach blocks EM for the SIB structures shown in FIG. 78-81. Such structures, in the case of their limitation to two rows, in the EM can be placed in any type of vertical or horizontal scanning. In the case of configuring any of it multi-row, in the EM it can be placed as vertical scanning. Herewith the basis bco1 and bco2 can be attached to one side support, or to two separate side supports.

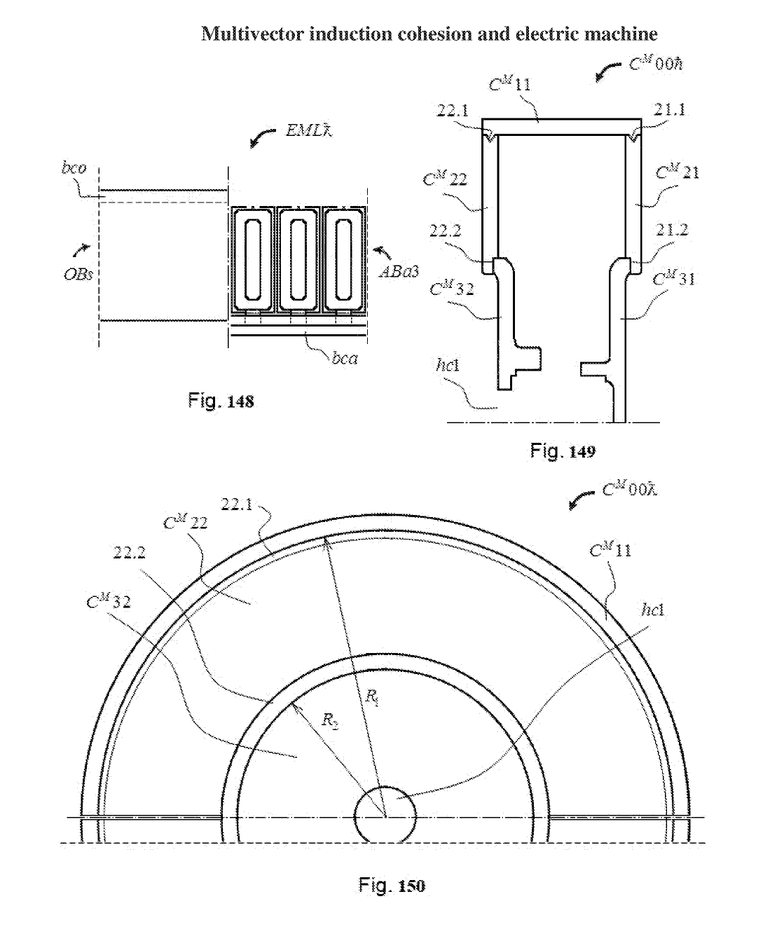

FIGS. 147 and 148 show, in the projection on [symbol] -plane (lateral plane) of EM, respectively, the rotational EM in the form of EMRh [symbol] and linear EM in the form of EML [symbol] .

EMR [symbol] is made vertically-two-block and can serve as an example for building a vertically-multi-block EM. EMRh [symbol] includes: upper compartment of blocks, comprising a single-vector electromagnetic block ABO and placed at its two lateral sides, the lateral non-source blocks OBs; lower compartment of blocks, comprises double-sided multiple-vector closed type electromagnetic block ABu and docked with it semicircle non-source block OBu. Intermediate platform bco is used for attachment, through the hubs, the non-source blocks OBs and OBu to the supporting central shaft or to the EM body. The intermediate platform bca serves for attachment of the electromagnetic blocks ABO and ABu to the support not occupied by the intermediate platform bco.

Linear EM in the form of EML [symbol] is performed as a vertically-single-block and it includes mentioned: double-sided multiple-vector open type electromagnetic block ABu and disposition at its two lateral sides, the lateral non-source OBs types of blocks, as well as inner non-source OBa3 block (not visible), which are attached to the intermediate platform bco. The intermediate platform bca can be attached to the supporting platform (base) of EM.

FIG. 149 shows in the projection on [symbol] -plane and on FIG. 150 in the projection on [symbol] -plane one of options of performing the body for the rotary EMs. FIGS. 149 and 150 show only one half of the rotationally symmetric image: the upper end side of the body, made in the form of two half-rings, only one half of C^{M} 11 is shown; the upper lateral sides of the body, made in the form of four circular disk-shaped half-rings, only two of which are shown C^{M} 21 and C^{M} 22; two lower lateral sides of the body, one of which is made in the form of a circular disc-shaped half-ring (with a hole for the central shaft), only one its half is shown C^{M} 32 and the other of which is made in a circular disc-shaped form, is shown only one half C^{M} 31. Each of these components of the body may be performed separately and demountable from each other.

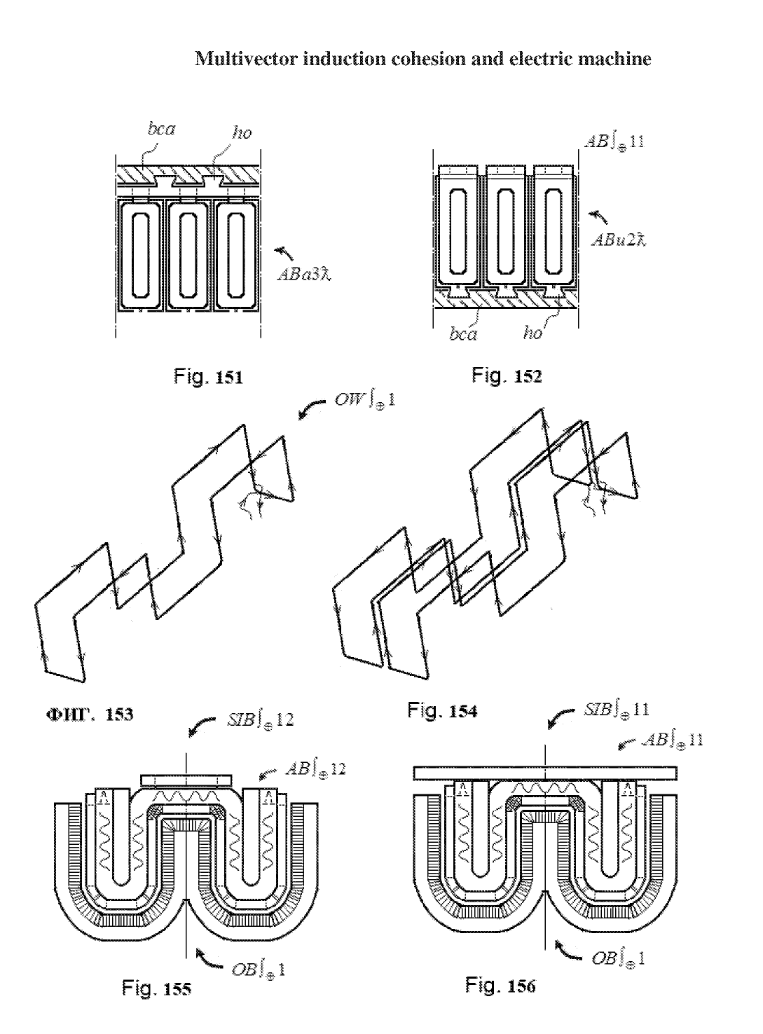

FIGS. 151 and 152 show the performance of mechanical hook ho to the intermediate platform bca, respectively: for sector of an open type of electromagnetic block ABa3 and in its composition of open type electromagnet AMa3, shown in projection on the [symbol] -plane in FIG. 126 ABa3 [symbol] ; for sector of a closed type of electromagnetic block ABu2 [symbol] and in its composition of closed type electromagnet ABu, shown in projection on the [symbol] -plane in FIG. 133 with curved shoes ABu2 [symbol] .

The principles of operation of any EM are well known, as mentioned, lay in motion relative to each other movable SSIB, and in production of electricity or mechanical motion.

1-68. (canceled)

69. The electric machine (EM), which comprises an outer body, a system of supports for different parts of the EM, and a system of inductive-interacting blocks (SIB), where the SIB is composed of at least two moving subsystems of inductive-interacting blocks (SSIB), each of which includes one or more induction blocks with internal structure, wherein at least one SSIB is electromagnetic subsystem of inductive-interacting blocks (SSAMB), comprising at least one electromagnetic induction block (AMB), wherein it has at least one feature selected from the group (a)-(c):
(a) its SIB is configured as multiple-vector and allowing multiple-vector inductive interaction between the SSIB and includes at least one electromagnet selected from the group consisting of the following: combination of some single-vector windings, which is configured with a core or without a core; symmetric or anti-symmetric multiple-vector winding, which is configured with a core or without a core;
(b) comprises at least one kind of permanent magnets selected from the group: closed-layered P_{G}-type permanent magnet; symmetric or anti-symmetric multiple-vector permanent magnet;
(c) its SIB is configured vertically multi-row and on a vertical includes more than one AMB.

70. The machine according to claim 69, characterized in that it is configured in one of its kinds:
linear EM with translational type SIB or reciprocating type SIB;
curvilinear EM with translational type SIB or reciprocating type SIB;
rotational EM with SIB selected from the group: of horizontal scanning; vertical scanning; mixed scanning.

71. The machine according to claim 70, characterized in the view of the multiple-vector winding and multiple-vector magnet selected from the group consisting of the following kinds of shapes: one-sided multiple-vector Γ-shaped; symmetric two-sided (Λ-shaped); anti-symmetric two-sided (Λ-shaped).

72. The machine according to claim 71, characterized in that in it the types of Λ-shaped winding and multiple-vector magnet types are selected from the group consisting of the following kinds: parallel two-sided with the straight upper side; parallel two-sided with the semi-ring upper side; divergent two-sided with the straight upper side; divergent two-sided with the sectoral-ring upper side; sector of the second-order curve.

73. The machine according to claim 71, characterized in that its multiple-vector electromagnet comprises a corresponding multiple-vector armatures of the electromagnet, which belongs to the group of kinds of armatures: Γ-shaped; open symmetric Λ-shaped; closed symmetric Λ-shaped; open anti-symmetric Λ-shaped; closed anti-symmetric Λ-shaped.

74. The machine according to claim 73, characterized in that in it the types of Λ-shaped armatures are selected from the group consisting of the following kinds: parallel two-sided with the straight upper side; parallel two-sided with the semi-ring upper side; divergent two-sided with the straight upper side; divergent two-sided with the sectoral-ring upper side; forms of a second-order curve.

75. The machine according to claim 73, characterized in that the electromagnet winding is configured in the form selected from the group consisting of the following kinds: collected, semi-collected and dispersed.

76. The machine according to claim 69, characterized in that it is configured in the form of EMSSOEB with source-off subsystem, wherein at least one of SSIB is configured in the form of source-off subsystem (SSOEB), and includes induction-inhomogeneous surroundings selected from the group comprising the following kinds: periodic protrusions and recesses (multi-cogged) made of magnetic-soft material; with co-directional and anti-directional permanent magnets of a periodic location on the surface, partially in the pocket or completely in the pocket of magnetic-soft material with air recesses or without recesses between the magnets.

77. The machine according to claim 70, characterized in that it comprises at least two SSOEBs, formed to allow the possibility to move, particularly to rotate, in one of the following ways: independently from each other; co-directionally; in opposite directions.

78. The machine according to claim 70, characterized in that its body comprises two separable from each other compartments—the compartment for the SIB and the compartment for the main support.

79. The machine according to claim 78, characterized in that in it the body compartments for SIB include: separable from each other the upper end part C^{M} 11, and two sides C^{M} 21 and C^{M} 22.

80. The machine according to claim 78, characterized in that it is configured linear and its body compartment for the main support includes a substrate for the supporting platform C^{M} 21.

81. The machine according to claim 78, characterized in that it is configured rotational and its body compartment for the main support includes two separable from each other C^{M} 31 and C^{M} 32 sides of the body for the SIB, with a central hole in one or two sides of the body for the SIB for the accommodation of the central support shaft.
